(19) United States
(12) Patent Application Publication
(10) Pub. No.: US 2024/0129759 A1
(43) Pub. Date: Apr. 18, 2024

(54) MACHINE LEARNING MODEL REPORTING, FALLBACK, AND UPDATING FOR WIRELESS COMMUNICATIONS

(71) Applicant: QUALCOMM INCORPORATED, San Diego, CA (US)

(72) Inventors: Yuwei Ren, Beijing (CN); Ruiming Zheng, Beijing (CN); Xipeng Zhu, San Diego, CA (US); Chenxi Hao, Beijing (CN); Shankar Krishnan, San Diego, CA (US); Yu Zhang, San Diego, CA (US); Huilin Xu, Temecula, CA (US); Hao Xu, Beijing (CN); Yin Huang, Beijing (CN); Taesang Yoo, San Diego, CA (US)

(21) Appl. No.: 18/546,568

(22) PCT Filed: Apr. 22, 2021
(86) PCT No.: PCT/CN2021/088896

§ 371 Date: Aug. 15, 2023

(51) Int. Cl. H04W 24/02; H04B 17/18; H04B 17/391; H04W 24/04

(52) U.S. Cl. CPC H04W 24/02; H04B 17/18; H04B 17/3913; H04W 24/04

(57) ABSTRACT

Methods, systems, and devices for wireless communications are described. In some systems, devices use machine learning (ML) models to support wireless communications. For example, a user equipment (UE) may download ML model information from a network to determine an ML model. The network may additionally configure a status reporting procedure, a fallback procedure, or both for the ML model. In some examples, based on a configuration, the UE may transmit a status report to a base station according to a reporting periodicity, a UE-based trigger, a network-based trigger, or some combination thereof. Additionally or alternatively, the UE may determine to fallback from operating using the ML model to operating in a second mode based on a fallback trigger. In some examples, to restore operating using a downloaded ML model, the UE may download an updated ML model or receive iterative updates to a previously downloaded ML model.

### CROSS REFERENCE

The present application is a 371 national stage filing of International PCT Application No. PCT/CN2021/088896 by Ren et al. entitled “MACHINE LEARNING MODEL REPORTING, FALLBACK, AND UPDATING FOR WIRELESS COMMUNICATIONS,” filed Apr. 22, 2021, which is assigned to the assignee hereof, and which is expressly incorporated by reference in its entirety herein.

### FIELD OF TECHNOLOGY

The following relates to wireless communications, including machine learning (ML) model reporting, fallback, and updating for wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a UE may use one or more machine learning (ML) models to support wireless communications. For example, the network may determine (e.g., train) an ML model and the UE may download the ML model to use in order to support one or more procedures at the UE. However, some operating conditions for a UE may negatively affect the performance of an ML model. For example, based on the actual inputs to the ML model during UE operation (which may depend on channel measurements or other current operating conditions), the ML model may perform poorly and degrade the performance of the UE (e.g., as compared to an alternative mode in which the UE does not use the ML model). Continuing to use the downloaded ML model under such operating conditions may reduce the UE's performance, communication reliability, or both.

### SUMMARY

The described techniques relate to improved methods, systems, devices, and apparatuses that support machine learning (ML) model reporting, fallback, and updating for wireless communications. Generally, the described techniques provide for techniques to effectively determine if an ML model is performing relatively poorly (e.g., below a performance threshold), report status information related to the ML model, and determine whether to fallback from operating using the ML model to operating in a different (e.g., default) mode. In some examples, a user equipment (UE) may download ML model information from a network to determine an ML model. The network may additionally configure a status reporting procedure, a fallback procedure, or both for the ML model in one or more configuration messages. In some examples, based on a configuration, the UE may trigger a transmission of a status report to a base station according to a configured reporting periodicity, a configured UE-based trigger, a configured network-based trigger, or some combination thereof. Additionally or alternatively, the UE may determine to fallback from operating using the ML model to operating in a second mode (e.g., using a different ML model or using a non-ML algorithm) based on a fallback trigger. If the UE falls back from using the ML model, the network may restore ML model usage at the UE by updating the ML model. In some examples, the UE may download a new ML model to use. In some other examples, the UE may receive iterative updates to a previously downloaded ML model and may use the updated ML model.

A method for wireless communications at a UE is described. The method may include receiving, from a base station, ML model information defining an ML model for the UE, receiving, from the base station, a configuration defining a trigger for reporting a status of the ML model, detecting the trigger for reporting the status of the ML model based on the configuration, and transmitting, to the base station, a report message indicating the status of the ML model based on detecting the trigger.

An apparatus for wireless communications at a UE is described. The apparatus may include a processor, memory coupled with the processor, and instructions stored in the memory. The instructions may be executable by the processor to cause the apparatus to receive, from a base station, ML model information defining an ML model for the UE, receive, from the base station, a configuration defining a trigger for reporting a status of the ML model, detect the trigger for reporting the status of the ML model based on the configuration, and transmit, to the base station, a report message indicating the status of the ML model based on detecting the trigger.

Another apparatus for wireless communications at a UE is described. The apparatus may include means for receiving, from a base station, ML model information defining an ML model for the UE, means for receiving, from the base station, a configuration defining a trigger for reporting a status of the ML model, means for detecting the trigger for reporting the status of the ML model based on the configuration, and means for transmitting, to the base station, a report message indicating the status of the ML model based on detecting the trigger.

A non-transitory computer-readable medium storing code for wireless communications at a UE is described. The code may include instructions executable by a processor to receive, from a base station, ML model information defining an ML model for the UE, receive, from the base station, a configuration defining a trigger for reporting a status of the ML model, detect the trigger for reporting the status of the ML model based on the configuration, and transmit, to the base station, a report message indicating the status of the ML model based on detecting the trigger.

Some examples of the method, apparatuses, and non-transitory computer-readable medium described herein may further include operations, features, means, or instructions for determining a periodic resource pattern for reporting the status of the ML model based on the configuration, where the report message may be transmitted in an uplink resource according to the periodic resource pattern.

Some examples of the method, apparatuses, and non-transitory computer-readable medium described herein may further include operations, features, means, or instructions for activating a timer in response to transmitting the report message and refraining from transmitting an additional report message according to the periodic resource pattern while the timer is activated.

In some examples of the method, apparatuses, and non-transitory computer-readable medium described herein, detecting the trigger may include operations, features, means, or instructions for triggering a transmission of the report message based on each periodic uplink resource of the periodic resource pattern, one or more conditions of the ML model satisfying one or more threshold conditions, an indication from the base station to report the status of the ML model, a priority of the ML model satisfying a priority threshold, or any combination thereof.

In some examples of the method, apparatuses, and non-transitory computer-readable medium described herein, detecting the trigger may include operations, features, means, or instructions for detecting a failure of the ML model based on a model outage detection method configured by the configuration, where the report message may be transmitted based on detecting the failure of the ML model.

Some examples of the method, apparatuses, and non-transitory computer-readable medium described herein may further include operations, features, means, or instructions for transmitting, to the base station, a model failure indication based on detecting the failure of the ML model and receiving, from the base station and in response to the model failure indication, a failure report query, where the report message may be transmitted in response to the failure report query.

In some examples of the method, apparatuses, and non-transitory computer-readable medium described herein, the configuration indicates a threshold number of failure instances and a timer, and detecting the failure of the ML model may include operations, features, means, or instructions for activating the timer in response to a first failure instance of the ML model, tracking a count value indicating a number of failure instances of the ML model, and determining that the count value satisfies the threshold number of failure instances prior to expiration of the activated timer, where the failure of the ML model may be detected in response to the determining that the count value satisfies the threshold number of failure instances.

In some examples of the method, apparatuses, and non-transitory computer-readable medium described herein, detecting the trigger may include operations, features, means, or instructions for receiving, from the base station, a configuration message indicating to report the status of the ML model, where the report message may be transmitted in response to the configuration message indicating to report the status of the ML model.

In some examples of the method, apparatuses, and non-transitory computer-readable medium described herein, the configuration message indicating to report the status of the ML model includes a model index corresponding to the ML model, a resource indication for transmission of the report message, a timer corresponding to the status of the ML model, a timestamp corresponding to the status of the ML model, or any combination thereof.

In some examples of the method, apparatuses, and non-transitory computer-readable medium described herein, receiving the ML model information and receiving the configuration may include operations, features, means, or instructions for receiving, from the base station, a model download message including the ML model information defining the ML model and the configuration defining the trigger for reporting the status of the ML model, where the configuration may be specific to the ML model.

In some examples of the method, apparatuses, and non-transitory computer-readable medium described herein, receiving the configuration may include operations, features, means, or instructions for receiving, from the base station, a model status reporting configuration message separate from the ML model information, the model status reporting configuration message including an indication of a model index corresponding to the ML model or an indication that the configuration corresponds to a general configuration for ML models.

In some examples of the method, apparatuses, and non-transitory computer-readable medium described herein, the report message may include: a status report for the ML model, the status report including at least a first model index corresponding to the ML model and the status of the ML model, where the status of the ML model includes model variation information for the ML model; a failure report for the ML model, the failure report including a payload size, an indication of a fallback mode, the first model index corresponding to the ML model, a second model index corresponding to a fallback ML model, the status of the ML model, or any combination thereof, where the status of the ML model includes input data to the ML model, statistics for the ML model, an output distribution of the ML model, or any combination thereof, or both.

A method for wireless communications at a base station is described. The method may include transmitting, to a UE, ML model information defining an ML model for the UE, transmitting, to the UE, a configuration for the UE to report a status of the ML model, and receiving, from the UE, a report message indicating the status of the ML model based on the configuration.

An apparatus for wireless communications at a base station is described. The apparatus may include a processor, memory coupled with the processor, and instructions stored in the memory. The instructions may be executable by the processor to cause the apparatus to transmit, to a UE, ML model information defining an ML model for the UE, transmit, to the UE, a configuration for the UE to report a status of the ML model, and receive, from the UE, a report message indicating the status of the ML model based on the configuration.

Another apparatus for wireless communications at a base station is described. The apparatus may include means for transmitting, to a UE, ML model information defining an ML model for the UE, means for transmitting, to the UE, a configuration for the UE to report a status of the ML model, and means for receiving, from the UE, a report message indicating the status of the ML model based on the configuration.

A non-transitory computer-readable medium storing code for wireless communications at a base station is described. The code may include instructions executable by a processor to transmit, to a UE, ML model information defining an ML model for the UE, transmit, to the UE, a configuration for the UE to report a status of the ML model, and receive, from the UE, a report message indicating the status of the ML model based on the configuration.

In some examples of the method, apparatuses, and non-transitory computer-readable medium described herein, the configuration defines a periodic resource pattern for the UE to report the status of the ML model and receiving the report message may include operations, features, means, or instructions for receiving the report message according to the periodic resource pattern.

In some examples of the method, apparatuses, and non-transitory computer-readable medium described herein, the configuration defines a model outage detection method and the method, apparatuses, and non-transitory computer-readable medium may include further operations, features, means, or instructions for receiving, from the UE, a model failure indication based on the model outage detection method and transmitting, to the UE and in response to the model failure indication, a failure report query, where the report message may be received in response to the failure report query.

Some examples of the method, apparatuses, and non-transitory computer-readable medium described herein may further include operations, features, means, or instructions for detecting a trigger to request the status of the ML model, the trigger including a performance loss associated with the UE satisfying a performance loss threshold, at least one condition associated with the ML model satisfying a status check threshold, or both, and transmitting, to the UE, a configuration message indicating for the UE to report the status of the ML model based on detecting the trigger, where the report message may be received in response to the configuration message indicating for the UE to report the status of the ML model.

A method for wireless communications at a UE is described. The method may include receiving, from a base station, ML model information defining a first ML model for the UE, operating using the first ML model based on receiving the ML model information, receiving, from the base station, a configuration indicating a fallback procedure for the first ML model, and triggering fallback from operating using the first ML model to operating using a second mode based on the fallback procedure, the second mode including a second ML model different from the first ML model, a non-ML algorithm, or both.

An apparatus for wireless communications at a UE is described. The apparatus may include a processor, memory coupled with the processor, and instructions stored in the memory. The instructions may be executable by the processor to cause the apparatus to receive, from a base station, ML model information defining a first ML model for the UE, operate using the first ML model based on receiving the ML model information, receive, from the base station, a configuration indicating a fallback procedure for the first ML model, and trigger fallback from operating using the first ML model to operating using a second mode based on the fallback procedure, the second mode including a second ML model different from the first ML model, a non-ML algorithm, or both.

Another apparatus for wireless communications at a UE is described. The apparatus may include means for receiving, from a base station, ML model information defining a first ML model for the UE, means for operating using the first ML model based on receiving the ML model information, means for receiving, from the base station, a configuration indicating a fallback procedure for the first ML model, and means for triggering fallback from operating using the first ML model to operating using a second mode based on the fallback procedure, the second mode including a second ML model different from the first ML model, a non-ML algorithm, or both.

A non-transitory computer-readable medium storing code for wireless communications at a UE is described. The code may include instructions executable by a processor to receive, from a base station, ML model information defining a first ML model for the UE, operate using the first ML model based on receiving the ML model information, receive, from the base station, a configuration indicating a fallback procedure for the first ML model, and trigger fallback from operating using the first ML model to operating using a second mode based on the fallback procedure, the second mode including a second ML model different from the first ML model, a non-ML algorithm, or both.

Some examples of the method, apparatuses, and non-transitory computer-readable medium described herein may further include operations, features, means, or instructions for monitoring a status of the first ML model based on operating using the first ML model, detecting a failure of the first ML model based on the configuration and the monitoring, and transmitting a report message including a failure report for the first ML model and indicating that the fallback is triggered based on detecting the failure of the first ML model.

In some examples of the method, apparatuses, and non-transitory computer-readable medium described herein, the report message indicates the second mode to which the UE falls back in response to detecting the failure of the first ML model.

In some examples of the method, apparatuses, and non-transitory computer-readable medium described herein, the report message includes a request for a fallback indication message and the method, apparatuses, and non-transitory computer-readable medium may include further operations, features, means, or instructions for receiving, from the base station and in response to the request, the fallback indication message indicating the second mode, where the fallback may be triggered in response to the fallback indication message.

In some examples of the method, apparatuses, and non-transitory computer-readable medium described herein, transmitting the report message may include operations, features, means, or instructions for transmitting, to the base station, the report message in an available uplink granted resource, a medium access control element (MAC-CE), or both based on detecting the failure of the first ML model, the report message including a model failure indication for the first ML model and data associated with the failure of the first ML model.

Some examples of the method, apparatuses, and non-transitory computer-readable medium described herein may further include operations, features, means, or instructions for transmitting, to the base station, a model failure indication for the first ML model in an available uplink granted resource, a scheduling request (SR), a MAC-CE, a radio resource control (RRC) configuration message, or any combination thereof based on detecting the failure of the first ML model and receiving, from the base station and in response to the model failure indication, an indication of an uplink resource to use for the report message including the failure report, where the report message may be transmitted in the uplink resource.

Some examples of the method, apparatuses, and non-transitory computer-readable medium described herein may further include operations, features, means, or instructions for triggering a physical random access channel (PRACH) procedure based on the detected failure of the first ML model corresponding to a primary cell (PCell) of the UE.

In some examples of the method, apparatuses, and non-transitory computer-readable medium described herein, the report message includes input data to the first ML model, statistics for the first ML model, a payload size, an indication of the fallback procedure, a first model index corresponding to the first ML model, a second model index corresponding to the second ML model, or any combination thereof.

Some examples of the method, apparatuses, and non-transitory computer-readable medium described herein may further include operations, features, means, or instructions for receiving, from the base station, a fallback indication message indicating the second mode, where the fallback may be triggered in response to the fallback indication message.

Some examples of the method, apparatuses, and non-transitory computer-readable medium described herein may further include operations, features, means, or instructions for receiving, from the base station and based on triggering the fallback, second ML model information defining a third ML model for the UE different from the first ML model and the second mode and operating using the third ML model based on receiving the second ML model information.

Some examples of the method, apparatuses, and non-transitory computer-readable medium described herein may further include operations, features, means, or instructions for receiving, from the base station and based on triggering the fallback, a configuration message indicating one or more updates to the first ML model for the UE, updating the first ML model based on the ML model information and the one or more updates, and operating using the updated first ML model based on receiving the configuration message indicating the one or more updates.

A method for wireless communications at a base station is described. The method may include transmitting, to a UE, ML model information defining a first ML model for the UE, triggering fallback for the UE from the first ML model to a second mode based on a fallback procedure for the first ML model, the second mode including a second ML model different from the first ML model, a non-ML algorithm, or both, and transmitting, to the UE and based on triggering the fallback, a fallback indication message indicating the second mode.

An apparatus for wireless communications at a base station is described. The apparatus may include a processor, memory coupled with the processor, and instructions stored in the memory. The instructions may be executable by the processor to cause the apparatus to transmit, to a UE, ML model information defining a first ML model for the UE, trigger fallback for the UE from the first ML model to a second mode based on a fallback procedure for the first ML model, the second mode including a second ML model different from the first ML model, a non-ML algorithm, or both, and transmit, to the UE and based on triggering the fallback, a fallback indication message indicating the second mode.

Another apparatus for wireless communications at a base station is described. The apparatus may include means for transmitting, to a UE, ML model information defining a first ML model for the UE, means for triggering fallback for the UE from the first ML model to a second mode based on a fallback procedure for the first ML model, the second mode including a second ML model different from the first ML model, a non-ML algorithm, or both, and means for transmitting, to the UE and based on triggering the fallback, a fallback indication message indicating the second mode.

A non-transitory computer-readable medium storing code for wireless communications at a base station is described. The code may include instructions executable by a processor to transmit, to a UE, ML model information defining a first ML model for the UE, trigger fallback for the UE from the first ML model to a second mode based on a fallback procedure for the first ML model, the second mode including a second ML model different from the first ML model, a non-ML algorithm, or both, and transmit, to the UE and based on triggering the fallback, a fallback indication message indicating the second mode.

Some examples of the method, apparatuses, and non-transitory computer-readable medium described herein may further include operations, features, means, or instructions for transmitting, to the UE, a configuration indicating the fallback procedure for the first ML model and receiving, from the UE, a report message including a failure report for the first ML model based on the configuration, where the fallback may be triggered in response to the failure report.

Some examples of the method, apparatuses, and non-transitory computer-readable medium described herein may further include operations, features, means, or instructions for transmitting, to the UE and based on triggering the fallback, second ML model information defining a third ML model for the UE different from the first ML model and the second mode, one or more updates to the first ML model for the UE, or both.

### BRIEF DESCRIPTION OF THE DRAWINGS

FIGS. 1 and 2 illustrate examples of wireless communications systems that support machine learning (ML) model reporting, fallback, and updating for wireless communications in accordance with aspects of the present disclosure.

FIGS. 3 through 7 illustrate examples of process flows that support ML model reporting, fallback, and updating for wireless communications in accordance with aspects of the present disclosure.

FIGS. 8 and 9 show block diagrams of devices that support ML model reporting, fallback, and updating for wireless communications in accordance with aspects of the present disclosure.

FIG. 10 shows a block diagram of a communications manager that supports ML model reporting, fallback, and updating for wireless communications in accordance with aspects of the present disclosure.

FIG. 11 shows a diagram of a system including a device that supports ML model reporting, fallback, and updating for wireless communications in accordance with aspects of the present disclosure.

FIGS. 12 and 13 show block diagrams of devices that support ML model reporting, fallback, and updating for wireless communications in accordance with aspects of the present disclosure.

FIG. 14 shows a block diagram of a communications manager that supports ML model reporting, fallback, and updating for wireless communications in accordance with aspects of the present disclosure.

FIG. 15 shows a diagram of a system including a device that supports ML model reporting, fallback, and updating for wireless communications in accordance with aspects of the present disclosure.

FIGS. 16 through 19 show flowcharts illustrating methods that support ML model reporting, fallback, and updating for wireless communications in accordance with aspects of the present disclosure.

### DETAILED DESCRIPTION

In some wireless communications systems, a user equipment (UE) may use one or more machine learning (ML) models to support wireless communications. For example, the wireless network may determine (e.g., train) an ML model and the UE may download the ML model to use in order to support one or more procedures at the UE. Some example ML models may support ML-based message compression, ML-based precoding, ML-based communication beam selection, and ML-based cell selection, among other examples. The UE may receive the ML model and operate using the ML model for wireless communications. However, some operating conditions at the UE may negatively affect the performance of an ML model. For example, based on the actual inputs to the ML model during UE operation (e.g., channel measurements, signal measurements, or other current operating conditions), the ML model may degrade the performance of the UE (e.g., as compared to an alternative mode in which the UE does not use the ML model). Continuing to use the downloaded ML model under such operating conditions may reduce the UE's performance, communication reliability, or both.

A wireless communications system may support one or more techniques for ML model reporting, fallback, and updating for wireless communications. A UE configured with such techniques may mitigate the relatively poor performance of an ML model and may maintain a communication link with other devices based on the ML model reporting, ML model fallback, ML model updating, or some combination thereof. In some examples, the UE may download ML model information from the network (e.g., via a base station) to determine an ML model. The network may additionally configure a status reporting procedure, a fallback procedure, or both for the ML model in one or more configuration messages. In some examples, based on a configuration, the UE may trigger a transmission of a status report to the base station according to a configured reporting periodicity, a configured UE-based trigger, a configured network-based trigger, or some combination thereof. Additionally or alternatively, the UE may determine to fallback from operating using the ML model to operating in a second mode (e.g., using a different ML model or using a non-ML algorithm) based on a fallback trigger. For example, the UE may fallback from using the ML model to maintain a communication link, satisfy a performance threshold, satisfy a reliability threshold, or some combination thereof. If the UE falls back from using the ML model, the network may restore ML model usage at the UE by updating the ML model. In some examples, the UE may download a new ML model to use. In some other examples, the UE may receive iterative updates to a previously downloaded ML model and may update the previously downloaded ML model. Updating the ML model may enable the UE to effectively use ML techniques in diverse operating conditions (e.g., conditions in which the previous ML model performed relatively poorly).

Aspects of the disclosure are initially described in the context of wireless communications systems. Additional aspects of the disclosure are described with reference to process flows. Aspects of the disclosure are further illustrated by and described with reference to apparatus diagrams, system diagrams, and flowcharts that relate to ML model reporting, fallback, and updating for wireless communications.

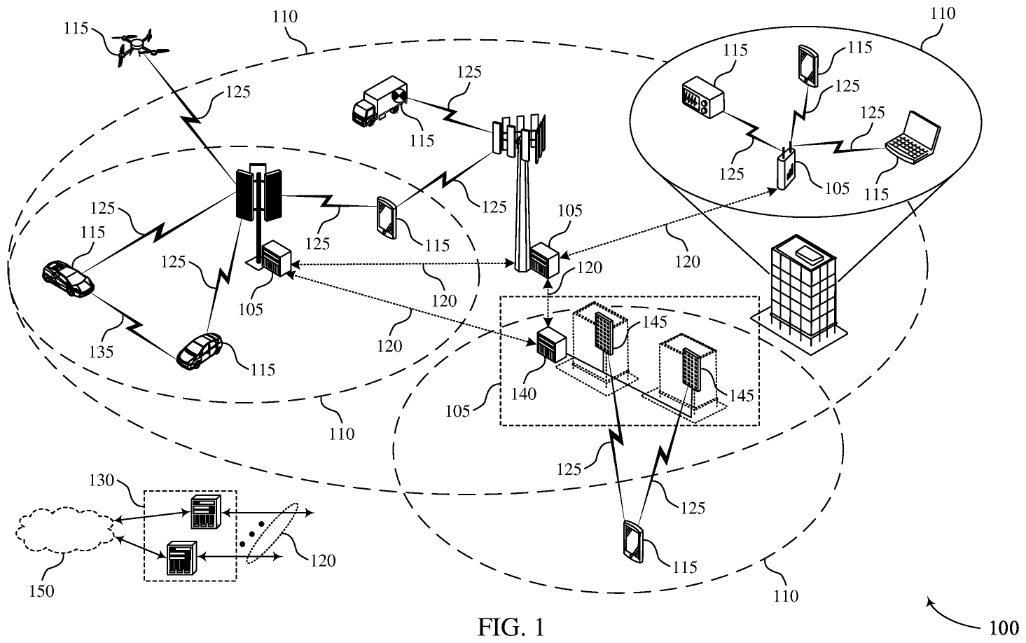

FIG. 1 illustrates an example of a wireless communications system 100 that supports ML model reporting, fallback, and updating for wireless communications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some wireless communications systems 100, devices may use ML models to support wireless communications functionality. For example, the network (e.g., a base station 105, a core network 130) may train an ML model and one or more UEs 115 may download (e.g., receive) the trained ML model from a base station 105. An ML model may support any number of features at a UE 115. For example, a UE 115 may use an ML model to determine a message compression process, perform pre-coding, select a beam for beamformed communications, or perform any number of other processes associated with wireless communications. However, an ML model trained by the network (e.g., trained offline by one or more UEs 115, trained in a test environment) may operate differently depending on the current operating conditions for a UE 115. For example, the UE 115 may provide inputs to the ML model based on current operating conditions (e.g., channel measurements, signal measurements, UE capabilities). In some examples, the current operating conditions may cause the ML model to perform relatively poorly (e.g., below a performance threshold). Continuing to use such an ML model may degrade the performance of the UE 115, such that the UE 115 using the ML model to support wireless communications may perform relatively worse (e.g., may be more inefficient, may be less reliable) than another UE 115 not using the ML model (e.g., using a default mode).

To support indicating and mitigating ML models that are performing relatively poorly (e.g., below a performance threshold), the network may configure a status reporting procedure, a fallback procedure, or both for the ML model. For example, a base station 105 may transmit a configuration message to a UE 115 indicating a reporting configuration, a fallback configuration, or both. In some examples, based on the reporting configuration, the UE 115 may transmit a status report to a base station 105 according to a reporting periodicity, a UE-based trigger, a network-based trigger, or some combination thereof. Additionally or alternatively, the UE 115 may determine to fallback from operating using the ML model to operating in a second mode (e.g., a default mode, involving a different ML model or a non-ML algorithm) based on a fallback trigger. In some examples, to restore operating using a downloaded ML model, the UE 115 may receive an updated ML model or iterative updates to a previously downloaded ML model from a base station 105. Using such techniques, the UE 115 may report a current status of an ML model to the network and may fallback to a different mode to mitigate a performance loss if the ML model is performing relatively poorly.

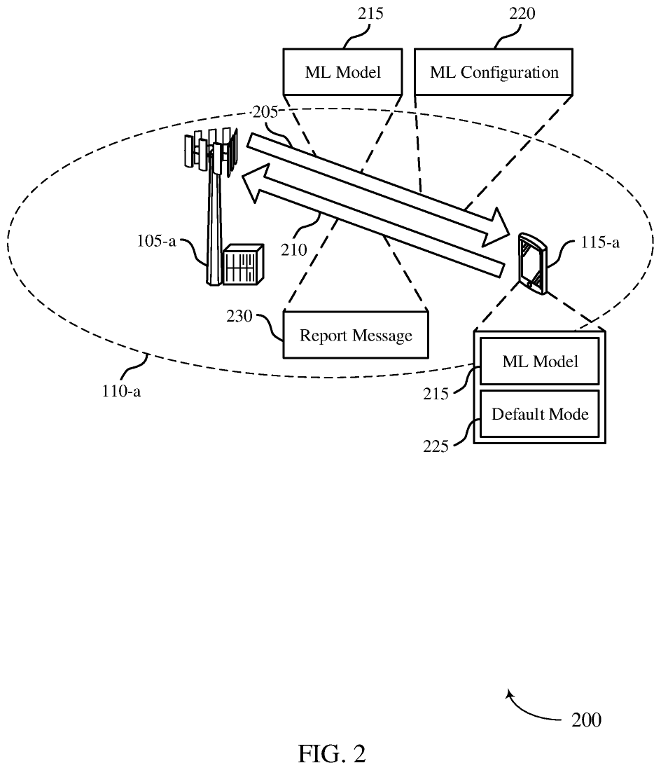

FIG. 2 illustrates an example of a wireless communications system 200 that supports ML model reporting, fallback, and updating for wireless communications in accordance with aspects of the present disclosure. The wireless communications system 200 may be an example of a wireless communications system 100. For example, the wireless communications system 200 may include a base station 105-a and a UE 115-a, which may be examples of the corresponding devices described with reference to FIG. 1. The base station 105-a may provide service for a coverage area 110-a. The base station 105-a may transmit messages to the UE 115-a over a downlink channel 205 and may receive messages from the UE 115-a over an uplink channel 210. In some cases, the base station 105-a may transmit an ML model 215 to the UE 115-a, such that the UE 115-a may use the ML model 215 to support one or more wireless communications operations. Additionally, the base station 105-a may configure the UE 115-a with an ML configuration 220, which may define a procedure for reporting a status of the ML model 215 (e.g., using a report message 230), a procedure for falling back from operating using the ML model 215 to operating using a default mode 225, or both. Such configurations may enable the UE 115-a to mitigate an ML model 215 that is performing worse than a performance threshold.

In some wireless communications systems 200, a base station 105-a, a UE 115-a, or both may use an ML model 215. The ML model 215 may be an example of a neural network that achieves a function Y=F(X), where the function F may be identified by a neural network function identifier (NNF-ID), X defines the input values to the ML model 215, and Y defines the output values for the ML model 215. The function, input parameters, and output parameters may be standardized by the network. For example, the network may determine ML model information-such as a model structure, a parameter set, or both—that define the ML model 215. The model structure may indicate a number of layers in a neural network, the weights for a neural network, the connections between layers for the neural network, or some combination thereof. The parameter set may indicate the parameters to input to the input nodes of the neural network, the values indicated by the output nodes of the neural network, or both. Some example input parameters may include channel state information (CSI), signal strength measurements, signal quality measurements, information bits for transmission, a latency threshold, a reliability threshold, or any other parameters associated with wireless communications. In some cases, the ML model information may be indicated using one or more identifiers corresponding to a specific neural network structure. The base station 105-a may transmit, to the UE 115-a, the ML model information defining the ML model 215 in an ML model download. The UE 115-a may receive the ML model information, determine the corresponding ML model 215, and operate using the ML model 215 based on the ML model download.

The UE 115-a, the base station 105-a, or both may perform ML inference. ML inference may involve inputting actual data into the ML model 215 and using the resulting outputs from the ML model 215. In some cases, ML inference may be performed at the network-side. In some other cases, ML inference may be performed at the UE-side. In yet some other cases, ML inference may be performed by both the network and the UE 115-a. In some examples, ML inference may be used for further training of an ML model 215, confirmation of an ML model 215, or both. If ML inference is performed by both the network and a UE 115-a, the network may configure matching ML models 215 at the network-side and the UE-side. Additionally or alternatively, if the UE 115-a uses an ML model 215 trained or otherwise configured by the network, the network may configure the ML model 215 for model inference at the UE 115-a. In some examples, ML model configuration may involve the base station 105-a transmitting ML model information (e.g., indicating the ML model 215), an ML configuration 220, or both to the UE 115-a.

The performance of an ML model 215 may vary depending on the device using the ML model 215, the current operating conditions for the device, or both. For example, a neural network-based ML model 215 may be unreliable (e.g., fail to satisfy a reliability threshold) in some operating conditions. Because machine learning is a data-driven solution, the quality of the data may determine the performance of the resulting ML model 215. For example, the data used for training an ML model 215 may fail to accurately represent one or more realistic deployment environments. Specifically, during ML model 215 preparation (e.g., at the base station 105-a or another network device), the training, validation, and testing of the ML model 215 may use one or more datasets that fail to cover specific potential scenarios (e.g., due to actual deployment environments being more complicated than some testing environments). Such shortcomings of the training data may result in an ML model 215 that performs relatively worse in a deployed scenario than in the test environment. Accordingly, the ML model 215 performance may vary significantly across diverse environments with different operating conditions.

To determine if the performance of an ML model 215 is below a performance threshold, the UE 115-a, the network, or both may monitor the status of an ML model 215. If the performance fails to satisfy the performance threshold, the UE 115-a, the network, or both may perform further training or optimization procedures to improve the performance of the ML model 215. ML model 215 status monitoring may involve performing ML model failure detection (e.g., monitoring if a communication link fails based on the ML model 215, corresponding to an ML model outage), verifying one or more outputs of the ML model 215 (e.g., using a predicted value, a default ML model or non-ML algorithm corresponding to a default mode 225, or some combination thereof), or both. If the UE 115-a using the ML model 215 detects an ML model outage or predicts that the output of the ML model 215 is incorrect or otherwise misleading (e.g., leading to worse performance than the default mode 225), the UE 115-a may perform a fallback procedure. The fallback procedure may involve switching from operating using the ML model 215 to operating using the default mode 225, which may include a default ML model pre-configured at the UE 115-a, a default, non-artificial intelligence (AI) algorithm pre-configured at the UE 115-a, or some combination thereof to perform the process previously handled by the ML model 215.

The network may use the ML configuration 220 to configure the UE 115-a for ML model 215 monitoring, reporting, fallback, updating, or any combination thereof. For example, the ML configuration 220 may configure one or more triggers for a UE 115-a to transmit a report message 230 to the base station 105-a. The report message 230 may indicate a status of an ML model 215, a detected failure of an ML model 215, or both. Additionally or alternatively, the report message 230 may indicate a fallback request or a fallback procedure such that the UE 115-a may maintain communication with one or more other devices (e.g., such as the base station 105-a). The ML configuration 220 may additionally or alternatively indicate the signaling design for the UE 115-a and the base station 105-a to support reporting, fallback, updating, or any combination thereof. Based on the ML configuration 220, the UE 115-a may detect if a downloaded ML model 215 is performing relatively poorly (e.g., below a performance threshold) and may perform one or more procedures (e.g., status reporting, fallback, model updating) to mitigate the performance degradation.

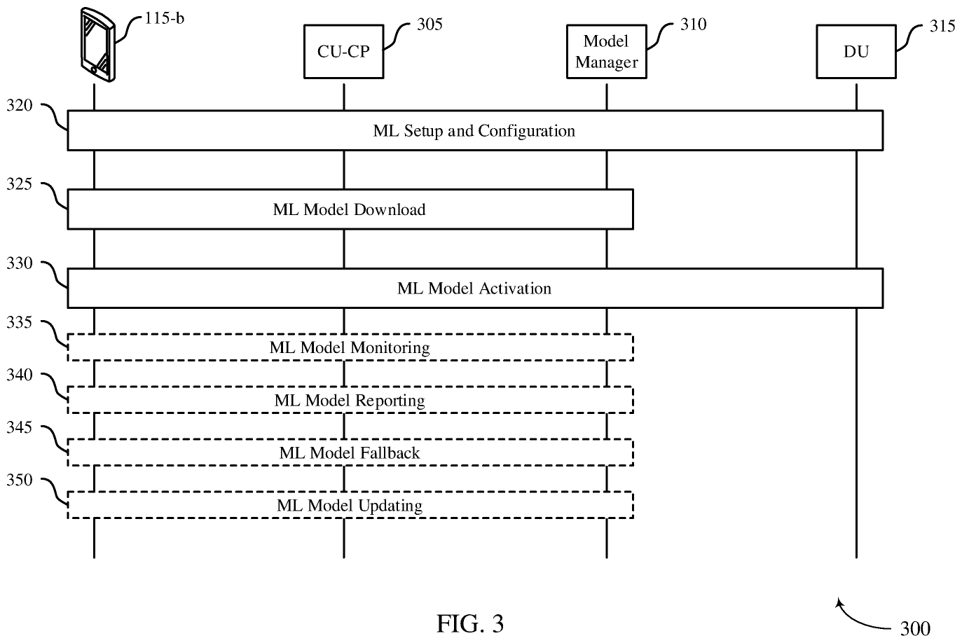

FIG. 3 illustrates an example of a process flow 300 that supports ML model reporting, fallback, and updating for wireless communications in accordance with aspects of the present disclosure. The process flow 300 may be implemented by a UE 115-b and one or more network entities (e.g., network devices), which may be examples of the corresponding devices described with reference to FIGS. 1 and 2. For example, the network entities may include a first logical node, such as a centralized unit control plane (CU-CP) 305; a second logical node, such as a centralized unit ML plane (CU-XP), which may operate as an ML model manager 310; and a third logical node, such as a distributed unit (DU) 315. A base station 105 may include or be in communication with the DU 315, the model manager 310, the CU-CP 305, or any combination of these components. The CU-CP 305, model manager 310, and DU 315 may coordinate to support functionality related to ML model reporting, fallback, and updating for wireless communications. Alternative examples of the following may be implemented, where some processes are performed in a different order than described or are not performed at all. In some cases, processes may include additional features not mentioned below, or further processes may be added.

At 320, the system may perform ML setup and configuration. For example, the CU-CP 305 may perform RRC connection setup with the UE 115-b. The CU-CP 305 may receive and determine a UE radio capability, a UE ML capability, or both based on the RRC connection setup. In some cases, based on the UE radio capability, the UE ML capability, or both, the CU-CP 305 may use one or more AI functions, ML models, or both. The CU-CP 305 may send, to the model manager 310, a UE context setup request. The UE context setup request may include the UE ML capability, a requested list of neural network functions, or both. The model manager 310 may send a model setup request to the DU 315 and receive a model setup response from the DU 315 based on the UE context setup request. The model manager 310 may send a UE context setup response to the CU-CP 305 in response to the UE context setup request. The UE context setup response may indicate an accepted list of neural network functions (e.g., based on the requested list of neural network functions), an ML container, or both. The CU-CP 305 may reconfigure the UE 115-b (e.g., using an RRC reconfiguration message) with the list of neural network functions, the ML container, or both. The UE 115-b may respond to the CU-CP 305 with an RRC reconfiguration complete message.

At 325, the system may perform an ML model download. For example, the UE 115-b may receive ML model information for a specific ML model (e.g., based on the list of neural network functions) from the CU-CP 305, which may retrieve the ML model information from the model manager 310. For example, the UE 115-b may receive the ML model download from the model manager 310 (e.g., via the CU-CP 305), where the ML model download may include model information, a model status reporting configuration, or both. In some cases, the UE 115-b may transmit ML uplink information to the CU-CP 305, including the ML container and an indication that a neural network function is ready for operation at the UE 115-b. The CU-CP 305 may send an ML uplink transfer to the model manager 310 including the ML container.

At 330, the system may perform ML model activation. In some cases, the UE 115-b may activate the ML model and operate using the ML model for one or more wireless communication functions. Additionally or alternatively, the network (e.g., the DU 315, the CU-CP 305, the model manager 310) may operate using the ML model.

Based on the ML configuration, the system may support tracking of a model status (e.g., using ML model monitoring at 335), configure and trigger ML model reporting at 340, configure and trigger ML model fallback at 345, configure and trigger ML model updating at 350, or some combination thereof. ML model fallback and updating may enable the UE 115-b to maintain a communication link if the performance of a downloaded ML model degrades (e.g., below a threshold). The ML model reporting may support control plane (CP) reporting (e.g., using RRC signaling), user plane (UP) reporting (e.g., using MAC layer signaling), or both. In some examples, the CU-CP 305 may configure the UE 115-b with a model monitoring method, a model outage detection method, or some combination thereof (e.g., during the ML model download or in a separate configuration). The CU-CP 305 may further forward reports (e.g., model status reports, model failure reports) from the UE 115-b to the model manager 310 and may support ML model reconfiguration at the UE 115-b. Accordingly, the network may use one or more network entities to support ML model reporting, fallback, and updating for a UE 115-b.

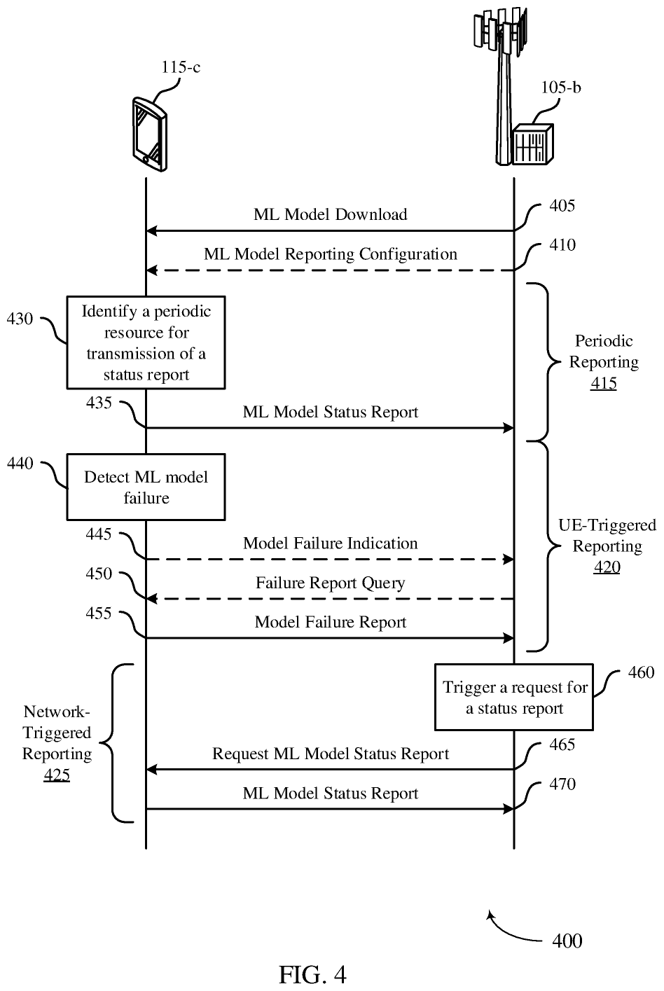

FIG. 4 illustrates an example of a process flow 400 that supports ML model reporting, fallback, and updating for wireless communications in accordance with aspects of the present disclosure. The process flow 400 may be implemented by a UE 115-c and a base station 105-b, which may be examples of the corresponding devices described with reference to FIGS. 1 through 3. In some cases, the base station 105-b may perform one or more operations described as being performed by the CU-CP 305, the model manager 310, the DU 315, or any combination thereof. Additionally or alternatively, one or more operations described as being performed by the base station 105-b may be performed by another network entity. The base station 105-b may configure the UE 115-c for ML model status reporting. Alternative examples of the following may be implemented, where some processes are performed in a different order than described or are not performed at all. In some cases, processes may include additional features not mentioned below, or further processes may be added.

At 405, the UE 115-c may download an ML model from the network. For example, the network may train or otherwise determine the ML model. The base station 105-b may transmit, and the UE 115-c may receive, ML model information (e.g., a model structure, model weights) defining the ML model for the UE 115-c.

Additionally, the UE 115-c may receive, from the base station 105-b, a configuration defining a trigger for reporting a status of the ML model. For example, the UE 115-c may receive the configuration of model status reporting in an RRC message. In some cases, the model status reporting configuration may be a static configuration, a semi-static configuration, or a dynamic configuration. Additionally or alternatively, the network may provide the configuration in a channel state feedback (CSF) procedure. The model status reporting configuration may indicate a method to detect the status of an ML model, a failure detection method, the content to include in a status report, a resource (e.g., time resource, frequency resource, spatial resource) for transmission of the status report, a timer for transmitting the status report, or any combination thereof.

In some examples, the base station 105-b may include the configuration of the reporting with the ML model download (e.g., at 405). For example, the configuration may be embedded with the ML model information in a model download message. Accordingly, the configuration of the reporting may be implicitly associated with a specific ML model (e.g., the ML model defined in the model download message).

In some other examples, the base station 105-b may transmit the configuration in a separate message from the ML model information. For example, the base station 105-b may transmit a model download message at 405 and may transmit a model status reporting configuration message at 410. In some cases, the model status reporting configuration message may indicate a general reporting configuration for any ML model. In some other cases, the model status reporting configuration message may indicate one or more ML model indices (e.g., using a bit field in the configuration message to indicate the one or more ML model indices). The reporting configuration defined by the model status reporting configuration message may apply to one or more specific ML models corresponding to the one or more ML model indices.

In a first example, the model status reporting configuration may specify periodic reporting 415 by the UE 115-c. Using RRC signaling (e.g., in the model status reporting configuration), the base station 105-b may configure periodic reporting from the UE 115-c to the network. For example, the base station 105-b may configure a periodic resource pattern, the content for the UE 115-c to include in the status report message, or both. In some cases, the periodic resource pattern may indicate a set of resources (e.g., time resources, frequency resources, spatial resources) within uplink resources to use for ML model status reporting. Additionally or alternatively, the base station 105-b may configure a timer for ML model status reporting. Within a duration of the timer, the UE 115-c may refrain from transmitting a status report or may transmit a single status report. For example, the UE 115-c may activate the timer in response to transmitting a status report message and may refrain from transmitting an additional report message while the timer is activated (e.g., even if another resource is configured for periodic status reporting within the duration of the timer). Using the timer may reduce the frequency of ML model status reporting by the UE 115-c, reducing processing overhead at the UE 115-c and reducing channel overhead.

At 430, the UE 115-c may identify a periodic resource for transmission of a status report. In some cases, identifying the periodic resource may be an example of detecting a trigger for reporting the status of an ML model. The UE 115-c may use one or more techniques for determining in which periodic resources to transmit a status report for an ML model. Based on the determination, the UE 115-c may transmit an ML model status report to the base station 105-b at 435 (e.g., in a periodically configured resource).

In some examples, the UE 115-c may report the model status for an ML model in each configured resource of the periodic resource pattern. In some other examples, the UE 115-c may analyze the status of an ML model and may transmit a status report for the ML model if one or more conditions of the ML model satisfy one or more threshold conditions (e.g., one or more pre-defined thresholds). For example, if using the ML model results in a communication reliability that fails to satisfy a threshold communication reliability, the UE 115-c may trigger transmission of a status report for the ML model in a periodic resource. In yet some other examples, the network (e.g., via the base station 105-b) may indicate one or more ML models to the UE 115-c for status reporting. For example, the base station 105-b may transmit a message (e.g., an RRC message, a MAC control element (CE), a downlink control information (DCI) message, a downlink data message, or any other downlink message) indicating one or more ML models for reporting (e.g., by indicating one or more ML model indices). The UE 115-c may transmit the status report message including status information for one or more of the ML models indicated by the network. In yet some other examples, the UE 115-c may determine status reporting based on priority levels for the ML models. For example, if a periodic resource for ML model status reporting conflicts with another scheduled communication or does not include sufficient resources for reporting the statuses for a set of ML models, the UE 115-c may refrain from reporting statuses for ML models with relatively low priority values and may report the statuses for ML models with relatively high priority values (e.g., satisfying a threshold priority level).

The ML model status report may include at least an indication of the ML model index and information related to the model variation. For example, the information related to the model variation may include a first bit value (e.g., “1”) if the performance of the ML model is degrading and a second bit value (e.g., “0”) if the performance of the ML model is improving. Additionally or alternatively, the ML model status report may include any number of other parameters or information related to an ML model. The UE 115-c may report the model status as a layer 2 (L2) measurement, a layer 3 (L3) measurement, or some combination thereof.

In a second example, the model status reporting configuration may specify UE-triggered reporting 420 by the UE 115-c. For example, the UE 115-c may be configured to actively transmit an ML model status report—or a request for resources to send an ML model status report—to the network in response to detecting a trigger for reporting the status of an ML model.

For example, the network may configure the UE 115-c (e.g., via the base station 105-b) with a model outage detection method. The UE 115-c may monitor the status of an ML model used at the UE 115-c. In some cases, at 440, the UE 115-c may detect a failure of the ML model. The failure of the ML model may involve the ML model causing the UE 115-c to lose a connection with another wireless device, reduce a channel quality below a channel quality threshold, reduce the performance of the UE 115-c below a performance threshold, or some combination thereof.

In some cases, at 445 and in response to detecting the ML model failure, the UE 115-c may transmit a model failure indication to the base station 105-b. In some examples, the model failure indication may include a request for model status reporting. At 450, the base station 105-b may transmit a failure report query to the UE 115-c. The failure report query may indicate resources for the UE 115-c to use for the report message (e.g., a model failure report message, a model status report message, or some combination thereof).

At 455, the UE 115-c may transmit the report message (e.g., a model failure report message, a model status report message, or some combination thereof) to the base station 105-b. In some cases, if the UE 115-c transmits the model failure indication at 445 and receives the failure report query at 450, the UE 115-c may transmit the model failure report message in response to the failure report query using resources configured by the failure report query. In some other cases, the UE 115-c may transmit the indication of the model failure with the model status (e.g., logged information, input data, or the like indicating information about the ML model failure) in a single message, such as the model failure report message, to the network at 455.

In some examples, the UE 115-c may detect ML model failure based on a number of times that the ML model fails. For example, the reporting configuration may define a threshold number of failure instances and a timer duration. If the ML model experiences a number of failures satisfying the threshold number of failure instances within the timer duration, the UE 115-c may trigger model failure reporting. For example, the UE 115-c may activate the timer upon detecting a first failure for an ML model and may track a count value indicating a number of failure instances of the ML model. If the count value satisfies (e.g., equals or exceeds) the threshold number of failure instances before the timer expires, the UE 115-c may trigger a transmission of a report message. If the timer expires without the count value satisfying the threshold number of failure instances, in some cases the UE 115-c may reset the count value to zero. In some examples, the timer, the count value, or both may correspond to a specific ML model or may correspond across ML models at the UE 115-c.

A failure instance for an ML model may be defined by the model failure detection method configuration (e.g., in the configuration message received at 410). In some examples, a failure instance may be directly indicated by the system performance (e.g., if a throughput loss at the UE 115-c exceeds a loss threshold). Additionally or alternatively, a failure instance may be indicated by one or more pre-defined rules, such as if the current latent code distribution fails to satisfy an expected range, the current confidence probability fails to satisfy a threshold value, or any combination of these or other rules defining failure instances for one or more ML models.

In a third example, the model status reporting configuration may specify network-triggered reporting 425 for the UE 115-c. For example, the network (e.g., the base station 105-b) may monitor one or more metrics associated with the UE 115-c, the ML model at the UE 115-c, or both. Based on the one or more metrics, the network may trigger an ML model status report. For example, if a performance loss of the UE 115-c satisfies a threshold performance loss, the network may trigger model status reporting from the UE 115-c (e.g., if the performance loss may potentially indicate an ML model failure at the UE 115-c). The network (e.g., via the base station 105-b) may configure and trigger the UE 115-c to report the ML model status (e.g., in a report message).

For example, at 460, the base station 105-b may trigger a request for a status report. The trigger may include a performance loss associated with the UE 115-c satisfying a performance loss threshold, at least one condition associated with the ML model satisfying a status check threshold, or some combination of these or other triggers for status reporting. At 465, in response to the trigger, the base station 105-b may transmit a configuration message to the UE 115-c configuring the UE 115-c to report an ML model status. The configuration message may include an ML model index indicating the ML model for status reporting, a resource indication for transmission of the report message by the UE 115-c, a timer or timestamp corresponding to the ML model status (e.g., where the UE 115-c may determine the status of the ML model at the timestamp or during the duration of the timer), or any combination thereof. The configuration message may be an example of an RRC message, a MAC-CE, a DCI message, a downlink data message, or any other message from the base station 105-b to the UE 115-c. The UE 115-c may generate a report message (e.g., an ML model status report message) based on the parameters indicated by the configuration message and may transmit the report message to the base station 105-b at 470. Accordingly, the UE 115-c may support request-based reporting of an ML model status (e.g., in dynamically configured resources).

In some examples, the network may configure the UE 115-c for one of periodic reporting 415, UE-triggered reporting 420, or network-triggered reporting 425. In some other examples, the network may configure the UE 115-c with some combination of periodic reporting 415, UE-triggered reporting 420, and network-triggered reporting 425. Additionally or alternatively, the UE 115-c may operate using multiple ML models (e.g., for different wireless communication functions) and may be configured with the same reporting configuration across ML models or may be configured with different reporting configurations for at least some ML models. In some cases, the UE 115-c may be pre-configured with an ML model reporting configuration (e.g., without receiving a configuration message from a base station 105-b). The reporting configuration for the UE 115-c may enable the UE 115-c to dynamically report status information for one or more ML models to the network, such that the network may determine problems with or updates to the one or more ML models.

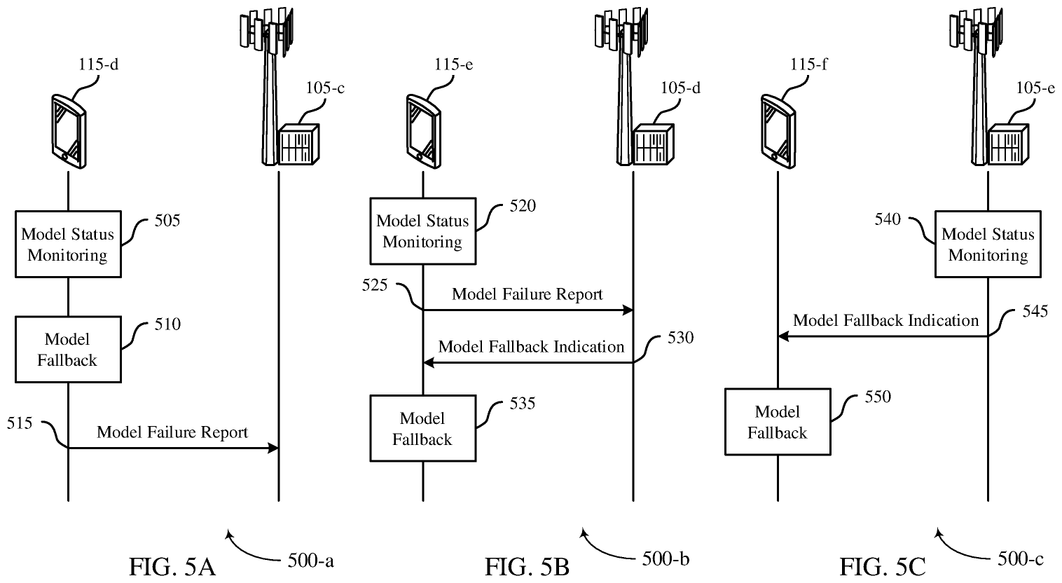

FIGS. 5A, 5B, and 5C illustrate examples of process flows 500 that support ML model reporting, fallback, and updating for wireless communications in accordance with aspects of the present disclosure. FIG. 5A illustrates an example of a process flow 500-a, in which a UE 115-d dynamically falls back from operating using an ML model independent of a base station 105-c. The UE 115-d and the base station 105-c may be examples of the corresponding devices described with reference to FIGS. 1 through 4. In some cases, the base station 105-c may perform one or more operations described as being performed by the CU-CP 305, the model manager 310, the DU 315, or any combination thereof. Additionally or alternatively, one or more operations described as being performed by the base station 105-c may be performed by another network entity. Alternative examples of the following may be implemented, where some processes are performed in a different order than described or are not performed at all. In some cases, processes may include additional features not mentioned below, or further processes may be added.

At 505, the UE 115-d may monitor the status of an ML model. In some cases, the UE 115-d may be configured with one or more methods for detecting ML model failure (e.g., as described with reference to FIG. 4). The UE 115-d may detect ML model failure based on the monitoring. For example, the UE 115-d may operate using a first ML model (e.g., an ML model downloaded from the base station 105-c). The UE 115-d may additionally receive, from the base station 105-c, a configuration indicating a fallback procedure for the first ML model. The fallback procedure may define one or more triggers for triggering fallback from operating using the first ML model to operating using a second mode. The second mode may be an example of a “default” mode. The second mode may involve operating using a second ML model (e.g., a pre-configured ML model at the UE 115-d), a non-ML algorithm (e.g., in a non-AI mode), or both.

At 510, the UE 115-d may trigger fallback from operating using the first ML model to operating using the second mode based on the fallback procedure. For example, based on one or more pre-defined rules, the UE 115-d may dynamically fallback without additional configuration (e.g., additional signaling) from the base station 105-c. At 515, the UE 115-d may transmit a model failure report message to the base station 105-c indicating the ML model failure and the fallback procedure. For example, the report message may indicate whether fallback was triggered at the UE 115-d and may indicate the second mode (e.g., the default mode) to which the UE 115-d falls back. The process flow 500-a may support the UE 115-d dynamically falling back from using an ML model (e.g., an ML model with relatively poor performance) independent of the network.

FIG. 5B illustrates an example of a process flow 500-b, in which a UE 115-e requests to fallback from operating using an ML model, and the network (e.g., via the base station 105-d) configures the fallback. The UE 115-e and the base station 105-d may be examples of the corresponding devices described with reference to FIGS. 1 through 4. In some cases, the base station 105-d may perform one or more operations described as being performed by the CU-CP 305, the model manager 310, the DU 315, or any combination thereof. Additionally or alternatively, one or more operations described as being performed by the base station 105-d may be performed by another network entity. Alternative examples of the following may be implemented, where some processes are performed in a different order than described or are not performed at all. In some cases, processes may include additional features not mentioned below, or further processes may be added.

At 520, the UE 115-e may monitor the status of an ML model. The UE 115-e may detect a failure of the ML model based on the monitoring. At 525, the UE 115-e may transmit a model failure report message to the base station 105-d. The model failure report message may indicate the ML model (e.g., using an ML model index) and may include a request to fallback from operating using the ML model. The network may receive the model failure report message and, at 530 and in response to the model failure report message, the base station 105-d may transmit a model fallback indication to the UE 115-e. The model fallback indication may be an example of a fallback configuration message (e.g., an RRC configuration message, a MAC-CE, a DCI message, a downlink data message, or another configuration message). In some cases, the fallback configuration message may include a bit indicating whether or not the UE 115-e is to fallback. The network may further configure the fallback procedure for the UE 115-e using the fallback configuration message. For example, the fallback configuration message may indicate the ML model from which to fallback (e.g., using an ML model index), a second mode to which to fallback (e.g., whether the UE 115-e is to fallback to a non-AI mode or to another ML model), or both. In some examples, the network may configure the fallback configuration based on one or more UE capabilities of the UE 115-e. For example, the network may refrain from triggering fallback for a relatively low-tier UE (e.g., with a limited capability as compared to other UEs 115).

At 535, the UE 115-e may trigger fallback in response to the model fallback indication from the base station 105-d. The UE 115-e may perform a fallback procedure configured by the fallback configuration message.

FIG. 5C illustrates an example of a process flow 500-c, in which the network (e.g., via a base station 105-e) triggers and configures fallback for a UE 115-f. The UE 115-f and the base station 105-e may be examples of the corresponding devices described with reference to FIGS. 1 through 4. In some cases, the base station 105-e may perform one or more operations described as being performed by the CU-CP 305, the model manager 310, the DU 315, or any combination thereof. Additionally or alternatively, one or more operations described as being performed by the base station 105-e may be performed by another network entity. Alternative examples of the following may be implemented, where some processes are performed in a different order than described or are not performed at all. In some cases, processes may include additional features not mentioned below, or further processes may be added.

At 540, the base station 105-e may monitor an ML model status. The UE 115-f, the base station 105-e, or both may operate using the ML model. The base station 105-e may trigger a fallback procedure for the UE 115-f based on the monitoring. For example, the base station 105-e may determine a failure of the ML model or may determine that the UE 115-f has fallen below a performance threshold (e.g., potentially due to the ML model). At 545, the base station 105-e may transmit a model fallback indication to the UE 115-f based on the monitoring. The model fallback indication may be an example of a fallback configuration message (e.g., an RRC configuration message, a MAC-CE, a DCI message, a downlink data message, or another configuration message) indicating the fallback procedure for the ML model. The UE 115-f may receive the model fallback indication and, at 550, may trigger fallback in response to the model fallback indication from the base station 105-e. Accordingly, the UE 115-f may perform a network-triggered fallback procedure configured by the fallback configuration message.

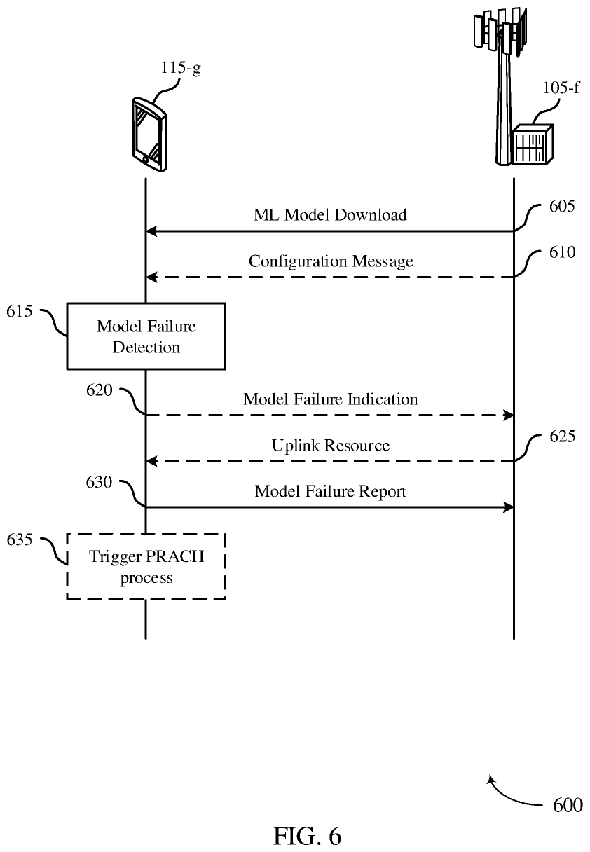

FIG. 6 illustrates an example of a process flow 600 that supports ML model reporting, fallback, and updating for wireless communications in accordance with aspects of the present disclosure. The process flow 600 may be implemented by a UE 115-g and a base station 105-f, which may be examples of the corresponding devices described with reference to FIGS. 1 through 5. In some cases, the base station 105-f may perform one or more operations described as being performed by the CU-CP 305, the model manager 310, the DU 315, or any combination thereof. Additionally or alternatively, one or more operations described as being performed by the base station 105-f may be performed by another network entity. The UE 115-g may trigger ML model failure reporting to the network (e.g., via the base station 105-f) based on a configuration of the UE 115-g. Alternative examples of the following may be implemented, where some processes are performed in a different order than described or are not performed at all. In some cases, processes may include additional features not mentioned below, or further processes may be added.

At 605, the UE 115-g may receive ML model information from the base station 105-f (e.g., in an ML model download). In some cases, the UE 115-g may additionally receive ML configuration information with the ML model download, the ML configuration information indicating a model failure reporting configuration for the UE 115-g. In some other cases, at 610, the UE 115-g may receive a separate configuration message indicating the ML model failure reporting configuration. In some examples, the ML model failure reporting configuration may include a scheduling request (SR) configuration, such that the UE 115-g may send an SR to schedule resources for a model failure report transmission.

At 615, the UE 115-g may detect a failure of an ML model. The UE 115-g may be configured (e.g., by the network) with one or more methods for detecting model failure. In some examples, a relatively large throughput loss (e.g., above a loss threshold) in the ML inference may trigger model failure detection. In some other examples, the ML model may include an embedded feature to detect whether failure occurs, or the UE 115-g may include another model to estimate the ML model status and detect if failure occurs. In some cases, the UE 115-g may use a soft-max-based solution, in which the UE 115-g may compare the probability density of the output from the in-distribution ML model to the output from an out-of-distribution ML model (e.g., determined during model training) to detect model failure. Additionally or alternatively, the UE 115-g may use an uncertainty solution, in which the UE 115-g may determine a predicted confidence for the ML model (e.g., using another ML model at the UE 115-g) to detect model failure. In some cases, the UE 115-g may use a generative model (e.g., if the ML model is associated with an auto-encoder), in which the UE 115-g may use the reconstruction error or other metrics associated with the auto-encoder structure to detect model failure. Additionally or alternatively, the UE 115-g may use feature space representation, in which the UE 115-g may analyze the feature space distribution of one or more inner layer outputs to detect model failure. In some cases, the UE 115-g may use any combination of these or other techniques to detect a failure of an ML model. In some examples, specific techniques may support early detection to avoid performance loss, while other techniques may support generic detection methods across multiple ML models.

In a first example, the UE 115-g may transmit a separate model failure indication and model failure report (e.g., including data reporting) to the base station 105-f in response to detecting the ML model failure. In a second example, the UE 115-g may transmit a combined model failure indication and report to the base station 105-f in response to detecting the ML model failure. In some cases, the UE 115-g may determine whether to transmit the model failure indication and the model failure report together or separately based on currently available uplink resources. For example, if the currently available uplink resources are not sufficient for the model failure report, the UE 115-g may transmit a separate model failure indication to trigger the network to configure sufficient uplink resources for the UE 115-g to transmit the model failure report.

In the first example, at 620, the UE 115-g may transmit a model failure indication to the base station 105-f (e.g., in an SR configured by the network). The UE 115-g may transmit the model failure indication using an available uplink grant, in a normal SR, in a dedicated SR, in a MAC-CE, or in an RRC message. In some examples, if a dedicated SR is configured for the UE 115-g, the UE 115-g may use the dedicated SR to request the resources for the model failure reporting without explicitly indicating a model failure indication. That is, the dedicated SR may act as an implicit model failure indication. If the UE 115-g uses a normal SR, the UE 115-g may include a model failure indication in the normal SR (e.g., one or more bits indicating the ML model index, that the ML model failed, or both), such that the network may receive the normal SR and determine an uplink grant suitable for the model failure reporting. At 625, the base station 105-f may indicate an uplink resource (e.g., in an uplink grant) to the UE 115-g for model failure reporting. The network may configure the uplink resource in response to the model failure indication. At 630, the UE 115-g may transmit the model failure report message in the configured uplink resource. The model failure report may be an example of an uplink shared channel message or a MAC-CE.

In the second example, at 630, the UE 115-g may transmit a model failure indication and a model failure report in a single message (e.g., without sending a separate model failure indication at 620 or receiving an uplink resource at 625). The UE 115-g may transmit the model failure indication and report using an available uplink grant or a MAC-CE. The report may include one bit indicating whether the ML model failed and may include additional bits for data reports (e.g., indicating data related to the ML model failure, the ML model status, or both).

The model failure report may include input data (e.g., which may have caused the failure) to the ML model, output data from the ML model, statistics associated with the ML model, a distribution associated with the ML model, a payload size of the report (e.g., associated with the amount of data included in the report), the ML model index for the failed ML model, a suggested ML model index (e.g., for updating the ML model at the UE 115-g), an indication of a fallback mode, a default mode index (e.g., for fallback), or any combination of this information or other reporting content. In some examples, the content of the model failure report may be based on a capability of the UE 115-g. For example, for a relatively low-tier UE, the model failure report may not include logged data (e.g., input data, output data, or both) for the ML model.

In some cases, the UE 115-g may transmit or refrain from transmitting the model failure report at 630 based on a priority order. For example, the UE 115-g may be configured with a set of priorities for different AI applications and other events (e.g., such as beam failure recovery (BFR) reporting). For example, if BFR reporting has a relatively higher priority order than AI-based CSF, and BFR reporting and AI-based CSF are triggered concurrently, the UE 115-g may transmit a BFR report in available uplink resources and may refrain from transmitting the model failure report in the uplink resources. Additionally or alternatively, AI-based control/data detection may have a relatively higher priority than AI-based CSF and may accordingly preempt model failure reporting. In some examples, the UE 115-g may use a timer to trigger model failure reporting. For example, the network may use an acknowledgment message to acknowledge successful receipt of a model failure report. When the UE 115-g transmits a model failure report, the UE 115-g may activate a timer (e.g., a prohibit timer). If the timer expires without the UE 115-g receiving an acknowledgment from the base station 105-f, the UE 115-g may trigger another model failure report transmission (e.g., due to not receiving acknowledgment from the network within the duration of the timer).

In some examples, at 635, the UE 115-g may determine that the ML model failure occurred on a primary cell (PCell). For example, the ML model failure may cause the UE 115-g to drop a connection with the PCell. The UE 115-g may trigger a physical random access channel (PRACH) process if the ML model failure occurs on the PCell. Additionally or alternatively, the UE 115-g may trigger the PRACH process if the UE 115-g fails to identify an available SR resource for a model failure indication or for a model failure report. The PRACH process may enable the UE 115-g to be configured with uplink resources for indicating model failure reporting to the network.

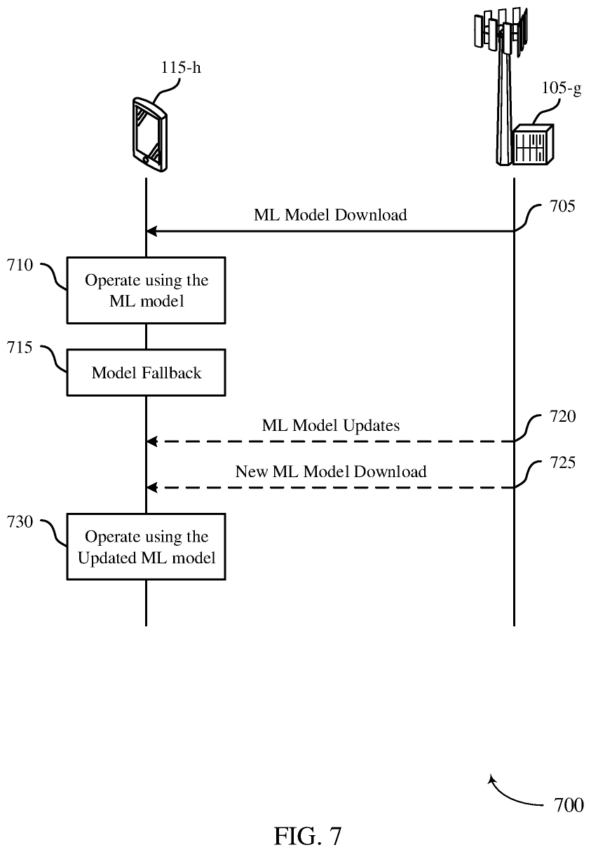

FIG. 7 illustrates an example of a process flow 700 that supports ML model reporting, fallback, and updating for wireless communications in accordance with aspects of the present disclosure. The process flow 700 may be implemented by a UE 115-h and a base station 105-g, which may be examples of the corresponding devices described with reference to FIGS. 1 through 6. In some cases, the base station 105-g may perform one or more operations described as being performed by the CU-CP 305, the model manager 310, the DU 315, or any combination thereof. Additionally or alternatively, one or more operations described as being performed by the base station 105-g may be performed by another network entity. The base station 105-g may update an ML model at the UE 115-h, for example, in response to an ML model failing at the UE 115-h, a fallback procedure at the UE 115-h, or both. Alternative examples of the following may be implemented, where some processes are performed in a different order than described or are not performed at all. In some cases, processes may include additional features not mentioned below, or further processes may be added.

At 705, the UE 115-h may receive, from the base station 105-g, ML model information defining a first ML model for the UE 115-h. At 710, the UE 115-h may operate using the first ML model based on receiving the ML model information. For example, the UE 115-h may generate the first ML model from the ML model information and may use the first ML model during wireless communications (e.g., for message compression, precoding, beam selection, or any number of other ML-supported processes).

At 715, the UE 115-h may perform a fallback procedure. For example, the UE 115-h may receive, from the base station 105-g, a configuration indicating a fallback procedure for the first ML model and may trigger fallback from operating using the first ML model to operating using a second mode based on the configured fallback procedure. The second mode may be a default mode and may involve using a second ML model different from the first ML model, a non-ML algorithm, or both.

The UE 115-h may update an ML model based on performing the fallback procedure. For example, performing the fallback procedure may indicate that the first ML model is performing relatively poorly (e.g., below a performance threshold) in the current operating conditions of the UE 115-h. The UE 115-h may report a status of the ML model, failure data related to the ML model, or both to the network (e.g., as described herein with reference to FIGS. 4 and 6). Based on the reporting information for the ML model, the network may perform further training (e.g., further optimization) of the ML model to improve the performance of the ML model in the operating conditions experienced by the UE 115-h. The network may update the ML model at the UE 115-h such that the UE 115-h may restore operating using the ML model (e.g., as opposed to operating in the second, default mode).

In a first example, at 720, the base station 105-g may configure the UE 115-h with updates to the first ML model (e.g., a previously downloaded ML model). For example, the base station 105-g may configure the difference between a new ML model determined at the network and the first ML model previously downloaded by the UE 115-h. The base station 105-g may transmit a configuration message (e.g., an RRC message, a MAC-CE) indicating the one or more updates to the first ML model. Accordingly, the UE 115-h may refrain from downloading an entirely new ML model from the base station 105-g. The UE 115-h may instead update the first ML model based on the ML model information received at 705 and the one or more updates received at 720. At 730, the UE 115-h may operate using the updated first ML model in response to receiving the configuration message indicating the one or more updates and based on updating the previously downloaded model.

In a second example, at 725, the base station 105-g may configure the UE 115-h with a new ML model determined at the network. For example, the UE 115-h may perform another ML model download (e.g., similar to at 705) to receive second ML model information defining a new ML model (e.g., a third ML model) for the UE 115-h different from the first ML model and the second mode. The base station 105-g may transmit a configuration message (e.g., an RRC message) configuring the ML information for the new ML model. In this way, the network may trigger a new model configuration and reset the ML model at the UE 115-h. At 730, the UE 115-h may operate using the new ML model in response to receiving the configuration for the new ML model.

Additionally or alternatively, the network may support other messaging with the UE 115-h based on ML model reporting, fallback, updating, or any combination thereof. For example, the network (e.g., via the base station 105-g) may provide acknowledgment signaling to the UE 115-h in response to one or more reports from the UE 115-h. The base station 105-g may receive a report message (e.g., including an ML status report, an ML failure report, or both) and may send an acknowledgment message in response. In some examples, the acknowledgment message may schedule another uplink grant with the same HARQ process identifier or new data indicator (NDI) as the uplink grant used for the report message transmission. Additionally or alternatively, the acknowledgment message may update the ML model (e.g., as described at 720 and 725), indicate a fallback mode for the UE 115-h, or both. In some examples, the acknowledgment message may be an example of an explicit RRC response message corresponding to an RRC message received from the UE 115-h (e.g., a model failure indication message). The network may additionally or alternatively configure report content for the UE 115-h. For example, the network may configure the UE 115-h to include in a model failure report the raw samples (e.g., input data to the ML model) which resulted in the model failure, one or more extracted features of the raw samples based on the configured failure detection method or model, or some combination of these or other potential report contents.

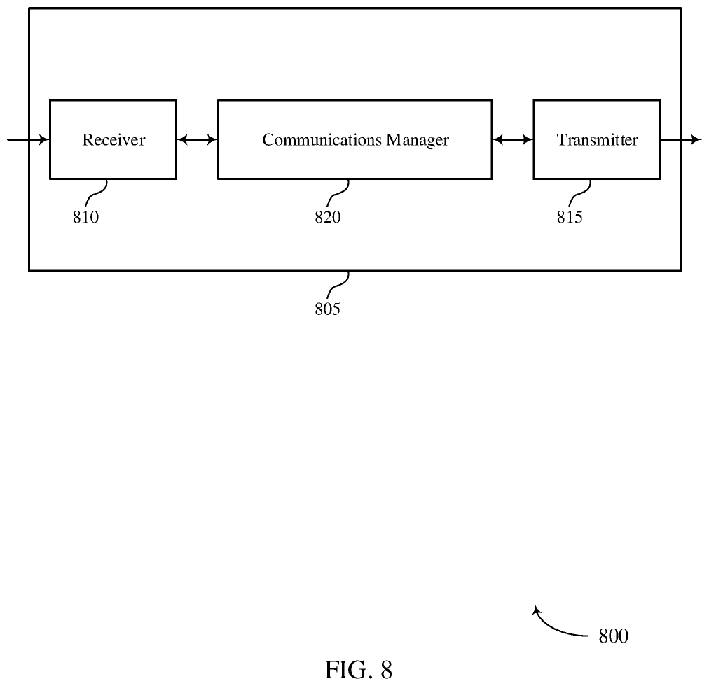

FIG. 8 shows a block diagram 800 of a device 805 that supports ML model reporting, fallback, and updating for wireless communications in accordance with aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to ML model reporting, fallback, and updating for wireless communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to ML model reporting, fallback, and updating for wireless communications). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of ML model reporting, fallback, and updating for wireless communications as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communications at a UE in accordance with examples as disclosed herein. For example, the communications manager 820 may be configured as or otherwise support a means for receiving, from a base station, ML model information defining an ML model for the UE. The communications manager 820 may be configured as or otherwise support a means for receiving, from the base station, a configuration defining a trigger for reporting a status of the ML model. The communications manager 820 may be configured as or otherwise support a means for detecting the trigger for reporting the status of the ML model based on the configuration. The communications manager 820 may be configured as or otherwise support a means for transmitting, to the base station, a report message indicating the status of the ML model based on detecting the trigger.

Additionally or alternatively, the communications manager 820 may support wireless communications at a UE in accordance with examples as disclosed herein. For example, the communications manager 820 may be configured as or otherwise support a means for receiving, from a base station, ML model information defining a first ML model for the UE. The communications manager 820 may be configured as or otherwise support a means for operating using the first ML model based on receiving the ML model information. The communications manager 820 may be configured as or otherwise support a means for receiving, from the base station, a configuration indicating a fallback procedure for the first ML model. The communications manager 820 may be configured as or otherwise support a means for triggering fallback from operating using the first ML model to operating using a second mode based on the fallback procedure, the second mode including a second ML model different from the first ML model, a non-ML algorithm, or both.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for improving UE performance and maintaining communication reliability. The communications manager 820 may support reporting a status associated with an ML model and falling back from using an ML model, for example, if the performance of the ML model degrades based on operating conditions at the communications manager 820. Falling back from using a failed ML model may enable the communications manager 820 to improve reliability and maintain a communication link, reducing the number of retransmissions and connection procedures performed by the communications manager 820. Reducing the number of retransmissions and connection procedures may effectively reduce a number of times the processor ramps up processing power and turns on processing units to handle communications.

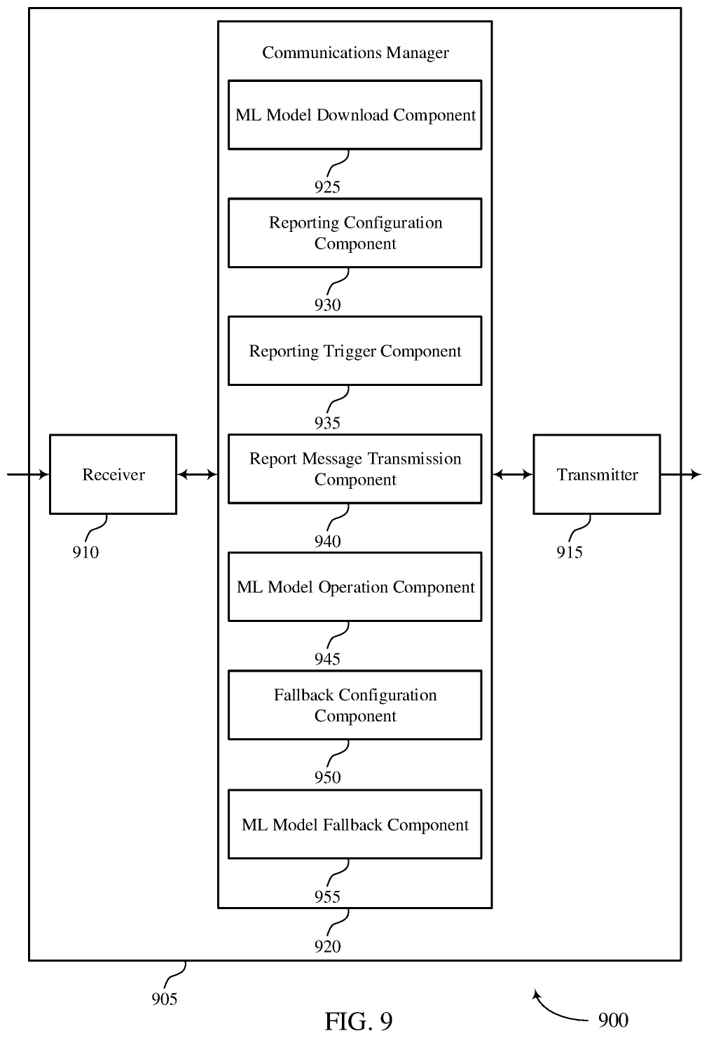

FIG. 9 shows a block diagram 900 of a device 905 that supports ML model reporting, fallback, and updating for wireless communications in accordance with aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to ML model reporting, fallback, and updating for wireless communications). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to ML model reporting, fallback, and updating for wireless communications). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of ML model reporting, fallback, and updating for wireless communications as described herein. For example, the communications manager 920 may include an ML model download component 925, a reporting configuration component 930, a reporting trigger component 935, a report message transmission component 940, an ML model operation component 945, a fallback configuration component 950, an ML model fallback component 955, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a UE in accordance with examples as disclosed herein. The ML model download component 925 may be configured as or otherwise support a means for receiving, from a base station, ML model information defining an ML model for the UE. The reporting configuration component 930 may be configured as or otherwise support a means for receiving, from the base station, a configuration defining a trigger for reporting a status of the ML model. The reporting trigger component 935 may be configured as or otherwise support a means for detecting the trigger for reporting the status of the ML model based on the configuration. The report message transmission component 940 may be configured as or otherwise support a means for transmitting, to the base station, a report message indicating the status of the ML model based on detecting the trigger.

Additionally or alternatively, the communications manager 920 may support wireless communications at a UE in accordance with examples as disclosed herein. The ML model download component 925 may be configured as or otherwise support a means for receiving, from a base station, ML model information defining a first ML model for the UE. The ML model operation component 945 may be configured as or otherwise support a means for operating using the first ML model based on receiving the ML model information. The fallback configuration component 950 may be configured as or otherwise support a means for receiving, from the base station, a configuration indicating a fallback procedure for the first ML model. The ML model fallback component 955 may be configured as or otherwise support a means for triggering fallback from operating using the first ML model to operating using a second mode based on the fallback procedure, the second mode including a second ML model different from the first ML model, a non-ML algorithm, or both.

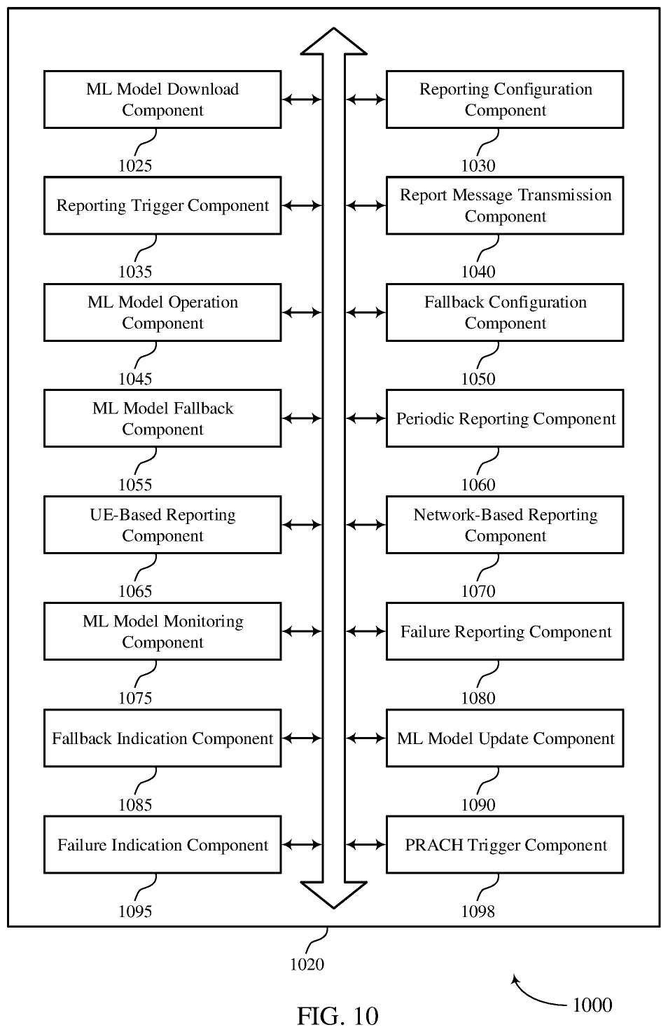

FIG. 10 shows a block diagram 1000 of a communications manager 1020 that supports ML model reporting, fallback, and updating for wireless communications in accordance with aspects of the present disclosure. The communications manager 1020 may be an example of aspects of a communications manager 820, a communications manager 920, or both, as described herein. The communications manager 1020, or various components thereof, may be an example of means for performing various aspects of ML model reporting, fallback, and updating for wireless communications as described herein. For example, the communications manager 1020 may include an ML model download component 1025, a reporting configuration component 1030, a reporting trigger component 1035, a report message transmission component 1040, an ML model operation component 1045, a fallback configuration component 1050, an ML model fallback component 1055, a periodic reporting component 1060, a UE-based reporting component 1065, a network-based reporting component 1070, an ML model monitoring component 1075, a failure reporting component 1080, a fallback indication component 1085, an ML model update component 1090, a failure indication component 1095, a PRACH trigger component 1098, or any combination thereof. Each of these components may communicate, directly or indirectly, with one another (e.g., via one or more buses).

The communications manager 1020 may support wireless communications at a UE in accordance with examples as disclosed herein. The ML model download component 1025 may be configured as or otherwise support a means for receiving, from a base station, ML model information defining an ML model for the UE. The reporting configuration component 1030 may be configured as or otherwise support a means for receiving, from the base station, a configuration defining a trigger for reporting a status of the ML model. The reporting trigger component 1035 may be configured as or otherwise support a means for detecting the trigger for reporting the status of the ML model based on the configuration. The report message transmission component 1040 may be configured as or otherwise support a means for transmitting, to the base station, a report message indicating the status of the ML model based on detecting the trigger.

In some examples, the periodic reporting component 1060 may be configured as or otherwise support a means for determining a periodic resource pattern for reporting the status of the ML model based on the configuration, where the report message is transmitted in an uplink resource according to the periodic resource pattern.

In some examples, the periodic reporting component 1060 may be configured as or otherwise support a means for activating a timer in response to transmitting the report message. In some examples, the periodic reporting component 1060 may be configured as or otherwise support a means for refraining from transmitting an additional report message according to the periodic resource pattern while the timer is activated.

In some examples, to support detecting the trigger, the periodic reporting component 1060 may be configured as or otherwise support a means for triggering a transmission of the report message based on each periodic uplink resource of the periodic resource pattern, one or more conditions of the ML model satisfying one or more threshold conditions, an indication from the base station to report the status of the ML model, a priority of the ML model satisfying a priority threshold, or any combination thereof.

In some examples, to support detecting the trigger, the UE-based reporting component 1065 may be configured as or otherwise support a means for detecting a failure of the ML model based on a model outage detection method configured by the configuration, where the report message is transmitted based on detecting the failure of the ML model.

In some examples, the UE-based reporting component 1065 may be configured as or otherwise support a means for transmitting, to the base station, a model failure indication based on detecting the failure of the ML model. In some examples, the UE-based reporting component 1065 may be configured as or otherwise support a means for receiving, from the base station and in response to the model failure indication, a failure report query, where the report message is transmitted in response to the failure report query.

In some examples, the configuration indicates a threshold number of failure instances and a timer and, to support detecting the failure of the ML model, the UE-based reporting component 1065 may be configured as or otherwise support a means for activating the timer in response to a first failure instance of the ML model. In some examples, to support detecting the failure of the ML model, the UE-based reporting component 1065 may be configured as or otherwise support a means for tracking a count value indicating a number of failure instances of the ML model. In some examples, to support detecting the failure of the ML model, the UE-based reporting component 1065 may be configured as or otherwise support a means for determining that the count value satisfies the threshold number of failure instances prior to expiration of the activated timer, where the failure of the ML model is detected in response to the determining that the count value satisfies the threshold number of failure instances.

In some examples, to support detecting the trigger, the network-based reporting component 1070 may be configured as or otherwise support a means for receiving, from the base station, a configuration message indicating to report the status of the ML model, where the report message is transmitted in response to the configuration message indicating to report the status of the ML model.

In some examples, the configuration message indicating to report the status of the ML model includes a model index corresponding to the ML model, a resource indication for transmission of the report message, a timer corresponding to the status of the ML model, a timestamp corresponding to the status of the ML model, or any combination thereof.

In some examples, to support receiving the ML model information and receiving the configuration, the reporting configuration component 1030 may be configured as or otherwise support a means for receiving, from the base station, a model download message including the ML model information defining the ML model and the configuration defining the trigger for reporting the status of the ML model, where the configuration is specific to the ML model.

In some examples, to support receiving the configuration, the reporting configuration component 1030 may be configured as or otherwise support a means for receiving, from the base station, a model status reporting configuration message separate from the ML model information, the model status reporting configuration message including an indication of a model index corresponding to the ML model or an indication that the configuration corresponds to a general configuration for ML models.

In some examples, the report message includes: a status report for the ML model, the status report including at least a first model index corresponding to the ML model and the status of the ML model, where the status of the ML model includes model variation information for the ML model; a failure report for the ML model, the failure report including a payload size, an indication of a fallback mode, the first model index corresponding to the ML model, a second model index corresponding to a fallback ML model, the status of the ML model, or any combination thereof, where the status of the ML model includes input data to the ML model, statistics for the ML model, an output distribution of the ML model, or any combination thereof, or both.

Additionally or alternatively, the communications manager 1020 may support wireless communications at a UE in accordance with examples as disclosed herein. In some examples, the ML model download component 1025 may be configured as or otherwise support a means for receiving, from a base station, ML model information defining a first ML model for the UE. The ML model operation component 1045 may be configured as or otherwise support a means for operating using the first ML model based on receiving the ML model information. The fallback configuration component 1050 may be configured as or otherwise support a means for receiving, from the base station, a configuration indicating a fallback procedure for the first ML model. The ML model fallback component 1055 may be configured as or otherwise support a means for triggering fallback from operating using the first ML model to operating using a second mode based on the fallback procedure, the second mode including a second ML model different from the first ML model, a non-ML algorithm, or both.

In some examples, the ML model monitoring component 1075 may be configured as or otherwise support a means for monitoring a status of the first ML model based on operating using the first ML model. In some examples, the ML model monitoring component 1075 may be configured as or otherwise support a means for detecting a failure of the first ML model based on the configuration and the monitoring. In some examples, the failure reporting component 1080 may be configured as or otherwise support a means for transmitting a report message including a failure report for the first ML model and indicating that the fallback is triggered based on detecting the failure of the first ML model.

In some examples, the report message indicates the second mode to which the UE falls back in response to detecting the failure of the first ML model.

In some examples, the report message includes a request for a fallback indication message, and the fallback indication component 1085 may be configured as or otherwise support a means for receiving, from the base station and in response to the request, the fallback indication message indicating the second mode, where the fallback is triggered in response to the fallback indication message.

In some examples, to support transmitting the report message, the failure reporting component 1080 may be configured as or otherwise support a means for transmitting, to the base station, the report message in an available uplink granted resource, a MAC-CE, or both based on detecting the failure of the first ML model, the report message including a model failure indication for the first ML model and data associated with the failure of the first ML model.

In some examples, the failure indication component 1095 may be configured as or otherwise support a means for transmitting, to the base station, a model failure indication for the first ML model in an available uplink granted resource, an SR, a MAC-CE, an RRC configuration message, or any combination thereof based on detecting the failure of the first ML model. In some examples, the failure indication component 1095 may be configured as or otherwise support a means for receiving, from the base station and in response to the model failure indication, an indication of an uplink resource to use for the report message including the failure report, where the report message is transmitted in the uplink resource.

In some examples, the PRACH trigger component 1098 may be configured as or otherwise support a means for triggering a PRACH procedure based on the detected failure of the first ML model corresponding to a PCell of the UE.

In some examples, the report message includes input data to the first ML model, statistics for the first ML model, a payload size, an indication of the fallback procedure, a first model index corresponding to the first ML model, a second model index corresponding to the second ML model, or any combination thereof.

In some examples, the fallback indication component 1085 may be configured as or otherwise support a means for receiving, from the base station, a fallback indication message indicating the second mode, where the fallback is triggered in response to the fallback indication message.

In some examples, the ML model update component 1090 may be configured as or otherwise support a means for receiving, from the base station and based on triggering the fallback, second ML model information defining a third ML model for the UE different from the first ML model and the second mode. In some examples, the ML model operation component 1045 may be configured as or otherwise support a means for operating using the third ML model based on receiving the second ML model information.

In some examples, the ML model update component 1090 may be configured as or otherwise support a means for receiving, from the base station and based on triggering the fallback, a configuration message indicating one or more updates to the first ML model for the UE. In some examples, the ML model update component 1090 may be configured as or otherwise support a means for updating the first ML model based on the ML model information and the one or more updates. In some examples, the ML model operation component 1045 may be configured as or otherwise support a means for operating using the updated first ML model based on receiving the configuration message indicating the one or more updates.

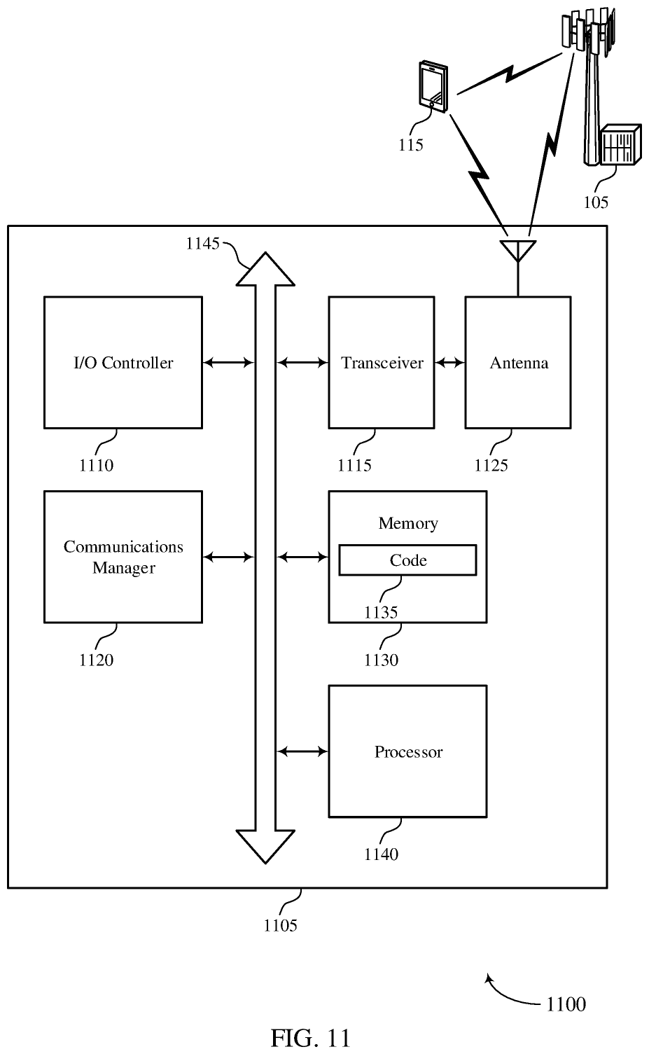

FIG. 11 shows a diagram of a system 1100 including a device 1105 that supports ML model reporting, fallback, and updating for wireless communications in accordance with aspects of the present disclosure. The device 1105 may be an example of or include the components of a device 805, a device 905, or a UE 115 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting ML model reporting, fallback, and updating for wireless communications). For example, the device 1105 or a component of the device 1105 may include a processor 1140 and memory 1130 coupled to the processor 1140, the processor 1140 and memory 1130 configured to perform various functions described herein.

The communications manager 1120 may support wireless communications at a UE in accordance with examples as disclosed herein. For example, the communications manager 1120 may be configured as or otherwise support a means for receiving, from a base station, ML model information defining an ML model for the UE. The communications manager 1120 may be configured as or otherwise support a means for receiving, from the base station, a configuration defining a trigger for reporting a status of the ML model. The communications manager 1120 may be configured as or otherwise support a means for detecting the trigger for reporting the status of the ML model based on the configuration. The communications manager 1120 may be configured as or otherwise support a means for transmitting, to the base station, a report message indicating the status of the ML model based on detecting the trigger.

Additionally or alternatively, the communications manager 1120 may support wireless communications at a UE in accordance with examples as disclosed herein. For example, the communications manager 1120 may be configured as or otherwise support a means for receiving, from a base station, ML model information defining a first ML model for the UE. The communications manager 1120 may be configured as or otherwise support a means for operating using the first ML model based on receiving the ML model information. The communications manager 1120 may be configured as or otherwise support a means for receiving, from the base station, a configuration indicating a fallback procedure for the first ML model. The communications manager 1120 may be configured as or otherwise support a means for triggering fallback from operating using the first ML model to operating using a second mode based on the fallback procedure, the second mode including a second ML model different from the first ML model, a non-ML algorithm, or both.

By including or configuring the communications manager 1120 in accordance with examples as described herein, the device 1105 may support techniques for ML model reporting, fallback, and updating. Supporting ML model status reporting may enable the device 1105 to dynamically indicate information related to an ML model to the network, such that the network may analyze and improve the ML model. Additionally or alternatively, supporting ML model fallback may enable the device 1105 to transition from operating using an ML model that fails to satisfy one or more performance thresholds and switch to operating in a second mode (e.g., a default mode) that satisfies the one or more performance thresholds. Supporting ML model updating may enable the device 1105 to dynamically update one or more ML models to improve performance in specific environments or under specific operating conditions.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of ML model reporting, fallback, and updating for wireless communications as described herein, or the processor 1140 and the memory 1130 may be otherwise configured to perform or support such operations.

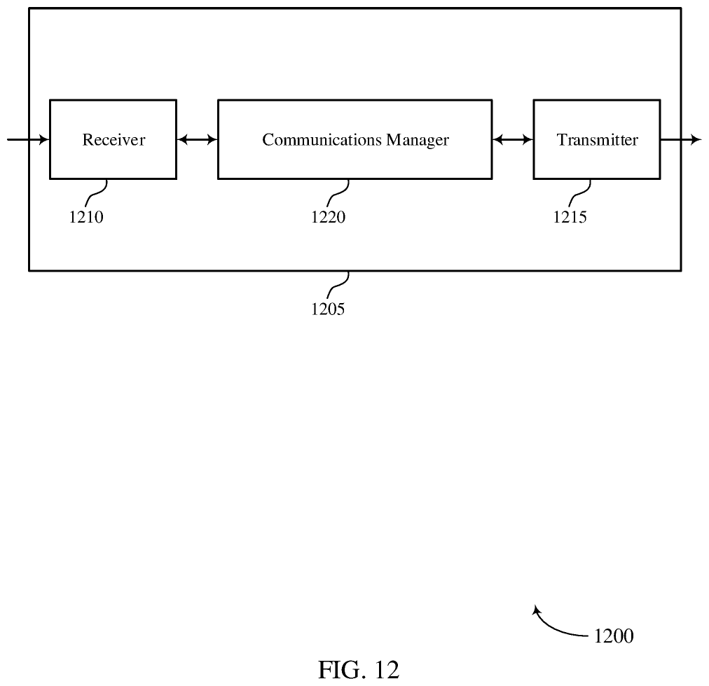

FIG. 12 shows a block diagram 1200 of a device 1205 that supports ML model reporting, fallback, and updating for wireless communications in accordance with aspects of the present disclosure. The device 1205 may be an example of aspects of a base station 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to ML model reporting, fallback, and updating for wireless communications). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to ML model reporting, fallback, and updating for wireless communications). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations thereof or various components thereof may be examples of means for performing various aspects of ML model reporting, fallback, and updating for wireless communications as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1220 may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communications at a base station in accordance with examples as disclosed herein. For example, the communications manager 1220 may be configured as or otherwise support a means for transmitting, to a UE, ML model information defining an ML model for the UE. The communications manager 1220 may be configured as or otherwise support a means for transmitting, to the UE, a configuration for the UE to report a status of the ML model. The communications manager 1220 may be configured as or otherwise support a means for receiving, from the UE, a report message indicating the status of the ML model based on the configuration.

Additionally or alternatively, the communications manager 1220 may support wireless communications at a base station in accordance with examples as disclosed herein. For example, the communications manager 1220 may be configured as or otherwise support a means for transmitting, to a UE, ML model information defining a first ML model for the UE. The communications manager 1220 may be configured as or otherwise support a means for triggering fallback for the UE from the first ML model to a second mode based on a fallback procedure for the first ML model, the second mode including a second ML model different from the first ML model, a non-ML algorithm, or both. The communications manager 1220 may be configured as or otherwise support a means for transmitting, to the UE and based on triggering the fallback, a fallback indication message indicating the second mode.

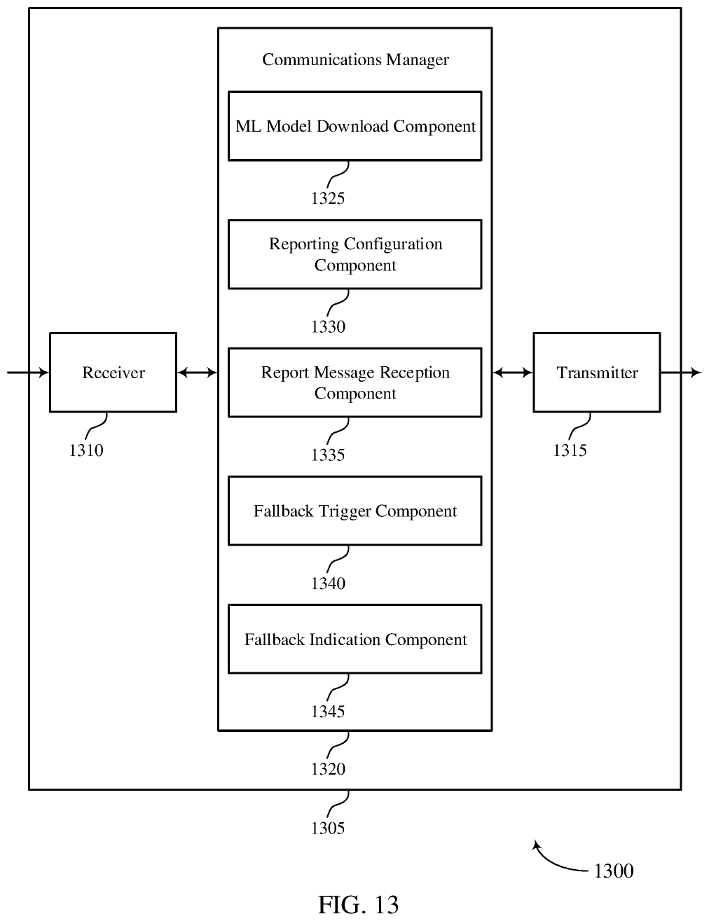

FIG. 13 shows a block diagram 1300 of a device 1305 that supports ML model reporting, fallback, and updating for wireless communications in accordance with aspects of the present disclosure. The device 1305 may be an example of aspects of a device 1205 or a base station 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to ML model reporting, fallback, and updating for wireless communications). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to ML model reporting, fallback, and updating for wireless communications). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of ML model reporting, fallback, and updating for wireless communications as described herein. For example, the communications manager 1320 may include an ML model download component 1325, a reporting configuration component 1330, a report message reception component 1335, a fallback trigger component 1340, a fallback indication component 1345, or any combination thereof. The communications manager 1320 may be an example of aspects of a communications manager 1220 as described herein. In some examples, the communications manager 1320, or various components thereof, may be configured to perform various operations (e.g., receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The communications manager 1320 may support wireless communications at a base station in accordance with examples as disclosed herein. The ML model download component 1325 may be configured as or otherwise support a means for transmitting, to a UE, ML model information defining an ML model for the UE. The reporting configuration component 1330 may be configured as or otherwise support a means for transmitting, to the UE, a configuration for the UE to report a status of the ML model. The report message reception component 1335 may be configured as or otherwise support a means for receiving, from the UE, a report message indicating the status of the ML model based on the configuration.

Additionally or alternatively, the communications manager 1320 may support wireless communications at a base station in accordance with examples as disclosed herein. The ML model download component 1325 may be configured as or otherwise support a means for transmitting, to a UE, ML model information defining a first ML model for the UE. The fallback trigger component 1340 may be configured as or otherwise support a means for triggering fallback for the UE from the first ML model to a second mode based on a fallback procedure for the first ML model, the second mode including a second ML model different from the first ML model, a non-ML algorithm, or both. The fallback indication component 1345 may be configured as or otherwise support a means for transmitting, to the UE and based on triggering the fallback, a fallback indication message indicating the second mode.

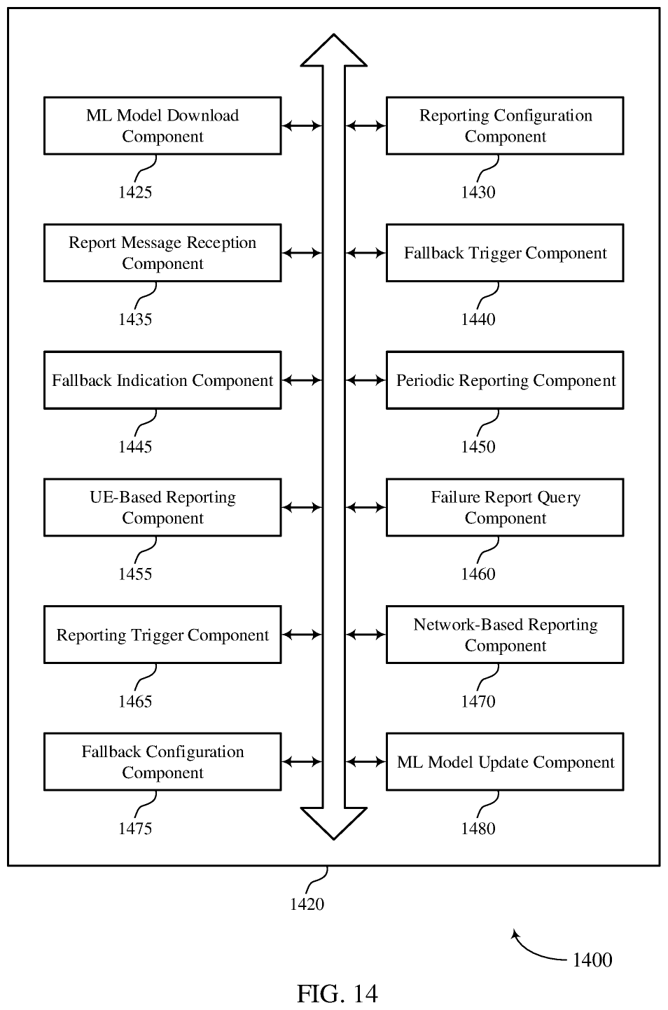

FIG. 14 shows a block diagram 1400 of a communications manager 1420 that supports ML model reporting, fallback, and updating for wireless communications in accordance with aspects of the present disclosure. The communications manager 1420 may be an example of aspects of a communications manager 1220, a communications manager 1320, or both, as described herein. The communications manager 1420, or various components thereof, may be an example of means for performing various aspects of ML model reporting, fallback, and updating for wireless communications as described herein. For example, the communications manager 1420 may include an ML model download component 1425, a reporting configuration component 1430, a report message reception component 1435, a fallback trigger component 1440, a fallback indication component 1445, a periodic reporting component 1450, a UE-based reporting component 1455, a failure report query component 1460, a reporting trigger component 1465, a network-based reporting component 1470, a fallback configuration component 1475, an ML model update component 1480, or any combination thereof. Each of these components may communicate, directly or indirectly, with one another (e.g., via one or more buses).

The communications manager 1420 may support wireless communications at a base station in accordance with examples as disclosed herein. The ML model download component 1425 may be configured as or otherwise support a means for transmitting, to a UE, ML model information defining an ML model for the UE. The reporting configuration component 1430 may be configured as or otherwise support a means for transmitting, to the UE, a configuration for the UE to report a status of the ML model. The report message reception component 1435 may be configured as or otherwise support a means for receiving, from the UE, a report message indicating the status of the ML model based on the configuration.

In some examples, the configuration defines a periodic resource pattern for the UE to report the status of the ML model. In some examples, to support receiving the report message, the periodic reporting component 1450 may be configured as or otherwise support a means for receiving the report message according to the periodic resource pattern.

In some examples, the configuration defines a model outage detection method, and the UE-based reporting component 1455 may be configured as or otherwise support a means for receiving, from the UE, a model failure indication based on the model outage detection method. In some examples, the failure report query component 1460 may be configured as or otherwise support a means for transmitting, to the UE and in response to the model failure indication, a failure report query, where the report message is received in response to the failure report query.

In some examples, the reporting trigger component 1465 may be configured as or otherwise support a means for detecting a trigger to request the status of the ML model, the trigger including a performance loss associated with the UE satisfying a performance loss threshold, at least one condition associated with the ML model satisfying a status check threshold, or both. In some examples, the network-based reporting component 1470 may be configured as or otherwise support a means for transmitting, to the UE, a configuration message indicating for the UE to report the status of the ML model based on detecting the trigger, where the report message is received in response to the configuration message indicating for the UE to report the status of the ML model.

Additionally or alternatively, the communications manager 1420 may support wireless communications at a base station in accordance with examples as disclosed herein. In some examples, the ML model download component 1425 may be configured as or otherwise support a means for transmitting, to a UE, ML model information defining a first ML model for the UE. The fallback trigger component 1440 may be configured as or otherwise support a means for triggering fallback for the UE from the first ML model to a second mode based on a fallback procedure for the first ML model, the second mode including a second ML model different from the first ML model, a non-ML algorithm, or both. The fallback indication component 1445 may be configured as or otherwise support a means for transmitting, to the UE and based on triggering the fallback, a fallback indication message indicating the second mode.

In some examples, the fallback configuration component 1475 may be configured as or otherwise support a means for transmitting, to the UE, a configuration indicating the fallback procedure for the first ML model. In some examples, the report message reception component 1435 may be configured as or otherwise support a means for receiving, from the UE, a report message including a failure report for the first ML model based on the configuration, where the fallback is triggered in response to the failure report.

In some examples, the ML model update component 1480 may be configured as or otherwise support a means for transmitting, to the UE and based on triggering the fallback, second ML model information defining a third ML model for the UE different from the first ML model and the second mode, one or more updates to the first ML model for the UE, or both.

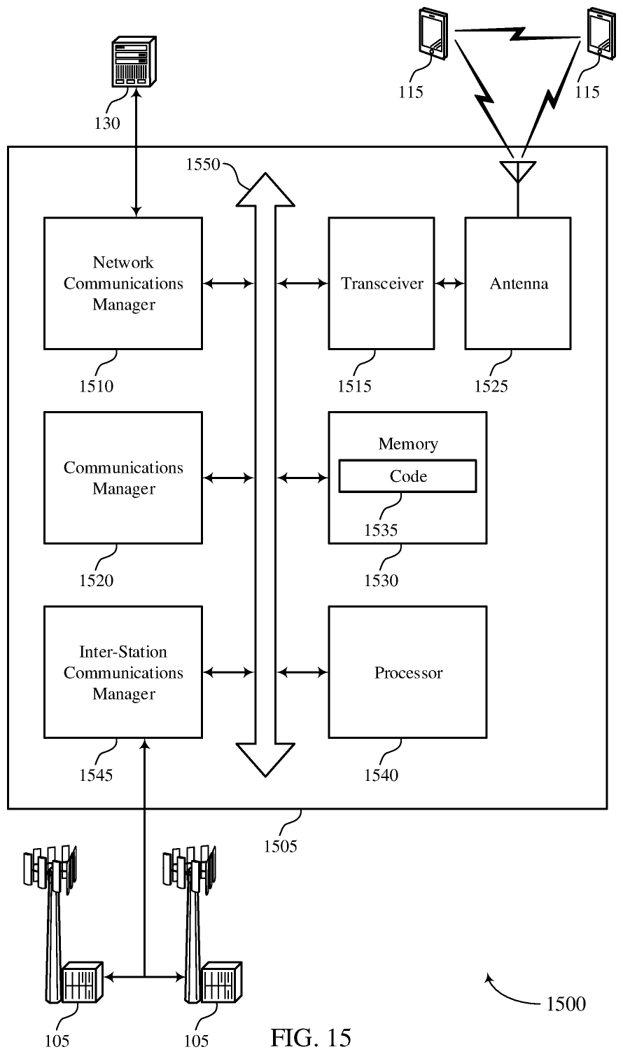

FIG. 15 shows a diagram of a system 1500 including a device 1505 that supports ML model reporting, fallback, and updating for wireless communications in accordance with aspects of the present disclosure. The device 1505 may be an example of or include the components of a device 1205, a device 1305, or a base station 105 as described herein. The device 1505 may communicate wirelessly with one or more base stations 105, UEs 115, or any combination thereof. The device 1505 may include components for bi-directional voice and data communications including components for transmitting and receiving communications, such as a communications manager 1520, a network communications manager 1510, a transceiver 1515, an antenna 1525, a memory 1530, code 1535, a processor 1540, and an inter-station communications manager 1545. These components may be in electronic communication or otherwise coupled (e.g., operatively, communicatively, functionally, electronically, electrically) via one or more buses (e.g., a bus 1550).

The network communications manager 1510 may manage communications with a core network 130 (e.g., via one or more wired backhaul links). For example, the network communications manager 1510 may manage the transfer of data communications for client devices, such as one or more UEs 115.

In some cases, the device 1505 may include a single antenna 1525. However, in some other cases the device 1505 may have more than one antenna 1525, which may be capable of concurrently transmitting or receiving multiple wireless transmissions. The transceiver 1515 may communicate bi-directionally, via the one or more antennas 1525, wired, or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The memory 1530 may include RAM and ROM. The memory 1530 may store computer-readable, computer-executable code 1535 including instructions that, when executed by the processor 1540, cause the device 1505 to perform various functions described herein. The code 1535 may be stored in a non-transitory computer-readable medium such as system memory or another type of memory. In some cases, the code 1535 may not be directly executable by the processor 1540 but may cause a computer (e.g., when compiled and executed) to perform functions described herein. In some cases, the memory 1530 may contain, among other things, a BIOS which may control basic hardware or software operation such as the interaction with peripheral components or devices.

The processor 1540 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In some other cases, a memory controller may be integrated into the processor 1540. The processor 1540 may be configured to execute computer-readable instructions stored in a memory (e.g., the memory 1530) to cause the device 1505 to perform various functions (e.g., functions or tasks supporting ML model reporting, fallback, and updating for wireless communications). For example, the device 1505 or a component of the device 1505 may include a processor 1540 and memory 1530 coupled to the processor 1540, the processor 1540 and memory 1530 configured to perform various functions described herein.

The inter-station communications manager 1545 may manage communications with other base stations 105, and may include a controller or scheduler for controlling communications with UEs 115 in cooperation with other base stations 105. For example, the inter-station communications manager 1545 may coordinate scheduling for transmissions to UEs 115 for various interference mitigation techniques such as beamforming or joint transmission. In some examples, the inter-station communications manager 1545 may provide an X2 interface within an LTE/LTE-A wireless communications network technology to provide communication between base stations 105.

The communications manager 1520 may support wireless communications at a base station in accordance with examples as disclosed herein. For example, the communications manager 1520 may be configured as or otherwise support a means for transmitting, to a UE, ML model information defining an ML model for the UE. The communications manager 1520 may be configured as or otherwise support a means for transmitting, to the UE, a configuration for the UE to report a status of the ML model. The communications manager 1520 may be configured as or otherwise support a means for receiving, from the UE, a report message indicating the status of the ML model based on the configuration.

Additionally or alternatively, the communications manager 1520 may support wireless communications at a base station in accordance with examples as disclosed herein. For example, the communications manager 1520 may be configured as or otherwise support a means for transmitting, to a UE, ML model information defining a first ML model for the UE. The communications manager 1520 may be configured as or otherwise support a means for triggering fallback for the UE from the first ML model to a second mode based on a fallback procedure for the first ML model, the second mode including a second ML model different from the first ML model, a non-ML algorithm, or both. The communications manager 1520 may be configured as or otherwise support a means for transmitting, to the UE and based on triggering the fallback, a fallback indication message indicating the second mode.

By including or configuring the communications manager 1520 in accordance with examples as described herein, the device 1505 may support techniques for ML model reporting, fallback, and updating at a UE. Supporting ML model status reporting may enable the device 1505 to dynamically receive information related to an ML model, such that the device 1505 may analyze and improve the ML model. Additionally or alternatively, supporting ML model fallback may enable the device 1505 to trigger (or otherwise configure) a UE to transition from operating using an ML model that fails to satisfy one or more performance thresholds to operating in a second mode that satisfies the one or more performance thresholds. Supporting ML model updating may enable the device 1505 to dynamically update a UE with one or more ML models to improve performance in specific environments or under specific operating conditions at the UE.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the processor 1540, the memory 1530, the code 1535, or any combination thereof. For example, the code 1535 may include instructions executable by the processor 1540 to cause the device 1505 to perform various aspects of ML model reporting, fallback, and updating for wireless communications as described herein, or the processor 1540 and the memory 1530 may be otherwise configured to perform or support such operations.

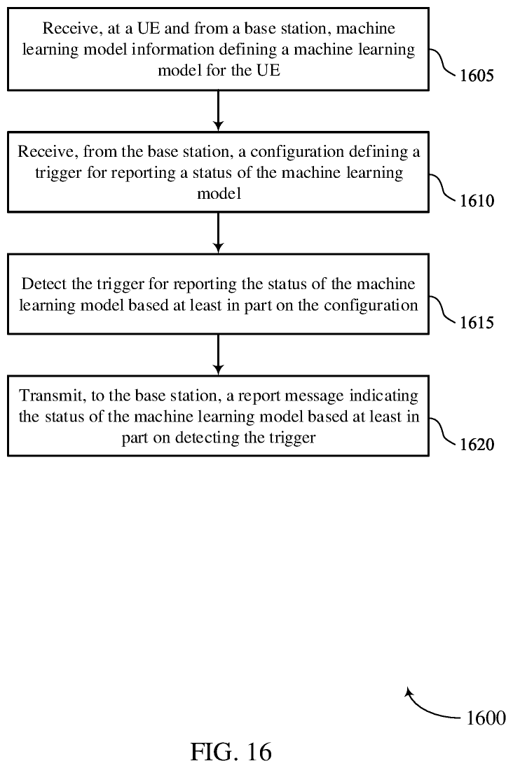

FIG. 16 shows a flowchart illustrating a method 1600 that supports ML model reporting, fallback, and updating for wireless communications in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1605, the method may include receiving, from a base station, ML model information defining an ML model for the UE. The operations of 1605 may be performed in accordance with examples as disclosed herein. In some examples, aspects of the operations of 1605 may be performed by an ML model download component 1025 as described with reference to FIG. 10.

At 1610, the method may include receiving, from the base station, a configuration defining a trigger for reporting a status of the ML model. The operations of 1610 may be performed in accordance with examples as disclosed herein. In some examples, aspects of the operations of 1610 may be performed by a reporting configuration component 1030 as described with reference to FIG. 10.

At 1615, the method may include detecting the trigger for reporting the status of the ML model based on the configuration. The operations of 1615 may be performed in accordance with examples as disclosed herein. In some examples, aspects of the operations of 1615 may be performed by a reporting trigger component 1035 as described with reference to FIG. 10.

At 1620, the method may include transmitting, to the base station, a report message indicating the status of the ML model based on detecting the trigger. The operations of 1620 may be performed in accordance with examples as disclosed herein. In some examples, aspects of the operations of 1620 may be performed by a report message transmission component 1040 as described with reference to FIG. 10.

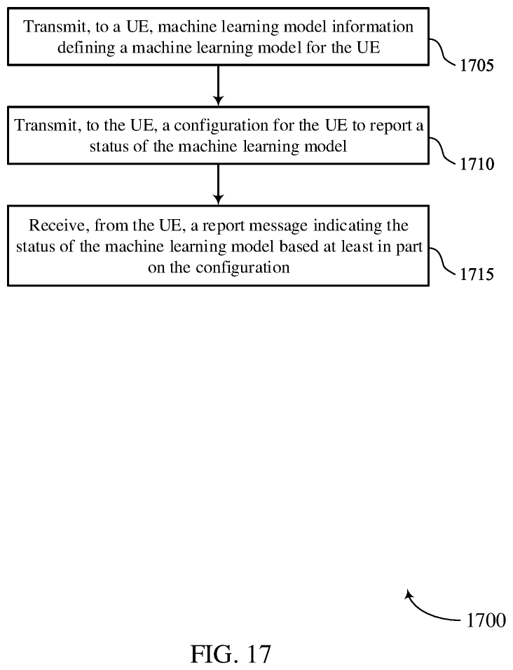

FIG. 17 shows a flowchart illustrating a method 1700 that supports ML model reporting, fallback, and updating for wireless communications in accordance with aspects of the present disclosure. The operations of the method 1700 may be implemented by a base station or its components as described herein. For example, the operations of the method 1700 may be performed by a base station 105 as described with reference to FIGS. 1 through 7 and 12 through 15. In some examples, a base station may execute a set of instructions to control the functional elements of the base station to perform the described functions. Additionally or alternatively, the base station may perform aspects of the described functions using special-purpose hardware.

At 1705, the method may include transmitting, to a UE, ML model information defining an ML model for the UE. The operations of 1705 may be performed in accordance with examples as disclosed herein. In some examples, aspects of the operations of 1705 may be performed by an ML model download component 1425 as described with reference to FIG. 14.

At 1710, the method may include transmitting, to the UE, a configuration for the UE to report a status of the ML model. The operations of 1710 may be performed in accordance with examples as disclosed herein. In some examples, aspects of the operations of 1710 may be performed by a reporting configuration component 1430 as described with reference to FIG. 14.

At 1715, the method may include receiving, from the UE, a report message indicating the status of the ML model based on the configuration. The operations of 1715 may be performed in accordance with examples as disclosed herein. In some examples, aspects of the operations of 1715 may be performed by a report message reception component 1435 as described with reference to FIG. 14.

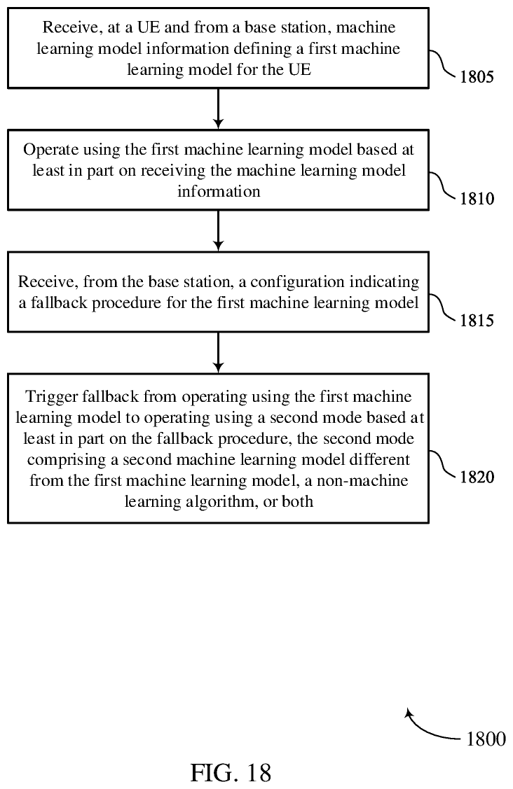

FIG. 18 shows a flowchart illustrating a method 1800 that supports ML model reporting, fallback, and updating for wireless communications in accordance with aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1805, the method may include receiving, from a base station, ML model information defining a first ML model for the UE. The operations of 1805 may be performed in accordance with examples as disclosed herein. In some examples, aspects of the operations of 1805 may be performed by an ML model download component 1025 as described with reference to FIG. 10.

At 1810, the method may include operating using the first ML model based on receiving the ML model information. The operations of 1810 may be performed in accordance with examples as disclosed herein. In some examples, aspects of the operations of 1810 may be performed by an ML model operation component 1045 as described with reference to FIG. 10.

At 1815, the method may include receiving, from the base station, a configuration indicating a fallback procedure for the first ML model. The operations of 1815 may be performed in accordance with examples as disclosed herein. In some examples, aspects of the operations of 1815 may be performed by a fallback configuration component 1050 as described with reference to FIG. 10.

At 1820, the method may include triggering fallback from operating using the first ML model to operating using a second mode based on the fallback procedure, the second mode including a second ML model different from the first ML model, a non-ML algorithm, or both. The operations of 1820 may be performed in accordance with examples as disclosed herein. In some examples, aspects of the operations of 1820 may be performed by an ML model fallback component 1055 as described with reference to FIG. 10.

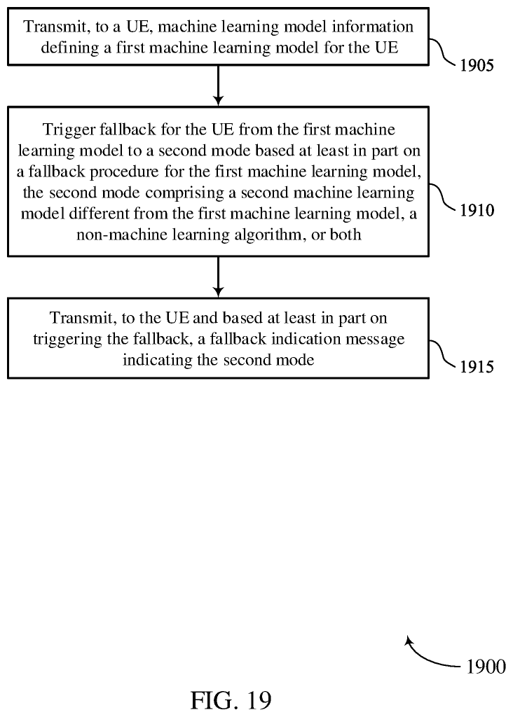

FIG. 19 shows a flowchart illustrating a method 1900 that supports ML model reporting, fallback, and updating for wireless communications in accordance with aspects of the present disclosure. The operations of the method 1900 may be implemented by a base station or its components as described herein. For example, the operations of the method 1900 may be performed by a base station 105 as described with reference to FIGS. 1 through 7 and 12 through 15. In some examples, a base station may execute a set of instructions to control the functional elements of the base station to perform the described functions. Additionally or alternatively, the base station may perform aspects of the described functions using special-purpose hardware.

At 1905, the method may include transmitting, to a UE, ML model information defining a first ML model for the UE. The operations of 1905 may be performed in accordance with examples as disclosed herein. In some examples, aspects of the operations of 1905 may be performed by an ML model download component 1425 as described with reference to FIG. 14.

At 1910, the method may include triggering fallback for the UE from the first ML model to a second mode based on a fallback procedure for the first ML model, the second mode including a second ML model different from the first ML model, a non-ML algorithm, or both. The operations of 1910 may be performed in accordance with examples as disclosed herein. In some examples, aspects of the operations of 1910 may be performed by a fallback trigger component 1440 as described with reference to FIG. 14.

At 1915, the method may include transmitting, to the UE and based on triggering the fallback, a fallback indication message indicating the second mode. The operations of 1915 may be performed in accordance with examples as disclosed herein. In some examples, aspects of the operations of 1915 may be performed by a fallback indication component 1445 as described with reference to FIG. 14.

The following provides an overview of aspects of the present disclosure:
Aspect 1: A method for wireless communications at a UE, comprising: receiving, from a base station, machine learning model information defining a machine learning model for the UE; receiving, from the base station, a configuration defining a trigger for reporting a status of the machine learning model; detecting the trigger for reporting the status of the machine learning model based at least in part on the configuration; and transmitting, to the base station, a report message indicating the status of the machine learning model based at least in part on detecting the trigger.
Aspect 2: The method of aspect 1, further comprising: determining a periodic resource pattern for reporting the status of the machine learning model based at least in part on the configuration, wherein the report message is transmitted in an uplink resource according to the periodic resource pattern.
Aspect 3: The method of aspect 2, further comprising: activating a timer in response to transmitting the report message; and refraining from transmitting an additional report message according to the periodic resource pattern while the timer is activated.
Aspect 4: The method of any of aspects 2 through 3, wherein detecting the trigger comprises: triggering a transmission of the report message based at least in part on each periodic uplink resource of the periodic resource pattern, one or more conditions of the machine learning model satisfying one or more threshold conditions, an indication from the base station to report the status of the machine learning model, a priority of the machine learning model satisfying a priority threshold, or any combination thereof.
Aspect 5: The method of any of aspects 1 through 4, wherein detecting the trigger comprises: detecting a failure of the machine learning model based at least in part on a model outage detection method configured by the configuration, wherein the report message is transmitted based at least in part on detecting the failure of the machine learning model.
Aspect 6: The method of aspect 5, further comprising: transmitting, to the base station, a model failure indication based at least in part on detecting the failure of the machine learning model; and receiving, from the base station and in response to the model failure indication, a failure report query, wherein the report message is transmitted in response to the failure report query.
Aspect 7: The method of any of aspects 5 through 6, wherein the configuration indicates a threshold number of failure instances and a timer and detecting the failure of the machine learning model comprises: activating the timer in response to a first failure instance of the machine learning model; tracking a count value indicating a number of failure instances of the machine learning model; and determining that the count value satisfies the threshold number of failure instances prior to expiration of the activated timer, wherein the failure of the machine learning model is detected in response to the determining that the count value satisfies the threshold number of failure instances.
Aspect 8: The method of any of aspects 1 through 7, wherein detecting the trigger comprises: receiving, from the base station, a configuration message indicating to report the status of the machine learning model, wherein the report message is transmitted in response to the configuration message indicating to report the status of the machine learning model.
Aspect 9: The method of aspect 8, wherein the configuration message indicating to report the status of the machine learning model comprises a model index corresponding to the machine learning model, a resource indication for transmission of the report message, a timer corresponding to the status of the machine learning model, a timestamp corresponding to the status of the machine learning model, or any combination thereof.
Aspect 10: The method of any of aspects 1 through 9, wherein receiving the machine learning model information and receiving the configuration comprises: receiving, from the base station, a model download message comprising the machine learning model information defining the machine learning model and the configuration defining the trigger for reporting the status of the machine learning model, wherein the configuration is specific to the machine learning model.
Aspect 11: The method of any of aspects 1 through 9, wherein receiving the configuration comprises: receiving, from the base station, a model status reporting configuration message separate from the machine learning model information, the model status reporting configuration message comprising an indication of a model index corresponding to the machine learning model or an indication that the configuration corresponds to a general configuration for machine learning models.
Aspect 12: The method of any of aspects 1 through 11, wherein the report message comprises: a status report for the machine learning model, the status report comprising at least a first model index corresponding to the machine learning model and the status of the machine learning model, wherein the status of the machine learning model comprises model variation information for the machine learning model; a failure report for the machine learning model, the failure report comprising a payload size, an indication of a fallback mode, the first model index corresponding to the machine learning model, a second model index corresponding to a fallback machine learning model, the status of the machine learning model, or any combination thereof, wherein the status of the machine learning model comprises input data to the machine learning model, statistics for the machine learning model, an output distribution of the machine learning model, or any combination thereof; or both.
Aspect 13: A method for wireless communications at a base station, comprising: transmitting, to a UE, machine learning model information defining a machine learning model for the UE; transmitting, to the UE, a configuration for the UE to report a status of the machine learning model; and receiving, from the UE, a report message indicating the status of the machine learning model based at least in part on the configuration.
Aspect 14: The method of aspect 13, wherein the configuration defines a periodic resource pattern for the UE to report the status of the machine learning model, and wherein receiving the report message comprises: receiving the report message according to the periodic resource pattern.
Aspect 15: The method of any of aspects 13 through 14, wherein the configuration defines a model outage detection method, the method further comprising: receiving, from the UE, a model failure indication based at least in part on the model outage detection method; and transmitting, to the UE and in response to the model failure indication, a failure report query, wherein the report message is received in response to the failure report query.
Aspect 16: The method of any of aspects 13 through 15, further comprising: detecting a trigger to request the status of the machine learning model, the trigger comprising a performance loss associated with the UE satisfying a performance loss threshold, at least one condition associated with the machine learning model satisfying a status check threshold, or both; and transmitting, to the UE, a configuration message indicating for the UE to report the status of the machine learning model based at least in part on detecting the trigger, wherein the report message is received in response to the configuration message indicating for the UE to report the status of the machine learning model.
Aspect 17: A method for wireless communications at a UE, comprising: receiving, from a base station, machine learning model information defining a first machine learning model for the UE; operating using the first machine learning model based at least in part on receiving the machine learning model information; receiving, from the base station, a configuration indicating a fallback procedure for the first machine learning model; and triggering fallback from operating using the first machine learning model to operating using a second mode based at least in part on the fallback procedure, the second mode comprising a second machine learning model different from the first machine learning model, a non-machine learning algorithm, or both.
Aspect 18: The method of aspect 17, further comprising: monitoring a status of the first machine learning model based at least in part on operating using the first machine learning model; detecting a failure of the first machine learning model based at least in part on the configuration and the monitoring; and transmitting a report message comprising a failure report for the first machine learning model and indicating that the fallback is triggered based at least in part on detecting the failure of the first machine learning model.
Aspect 19: The method of aspect 18, wherein the report message indicates the second mode to which the UE falls back in response to detecting the failure of the first machine learning model.
Aspect 20: The method of aspect 18, wherein the report message comprises a request for a fallback indication message, the method further comprising: receiving, from the base station and in response to the request, the fallback indication message indicating the second mode, wherein the fallback is triggered in response to the fallback indication message.
Aspect 21: The method of any of aspects 18 through 20, wherein transmitting the report message comprises: transmitting, to the base station, the report message in an available uplink granted resource, a medium access control element, or both based at least in part on detecting the failure of the first machine learning model, the report message comprising a model failure indication for the first machine learning model and data associated with the failure of the first machine learning model.
Aspect 22: The method of any of aspects 18 through 20, further comprising: transmitting, to the base station, a model failure indication for the first machine learning model in an available uplink granted resource, a scheduling request, a medium access control element, a radio resource control configuration message, or any combination thereof based at least in part on detecting the failure of the first machine learning model; and receiving, from the base station and in response to the model failure indication, an indication of an uplink resource to use for the report message comprising the failure report, wherein the report message is transmitted in the uplink resource.
Aspect 23: The method of any of aspects 18 through 22, further comprising: triggering a physical random access channel procedure based at least in part on the detected failure of the first machine learning model corresponding to a primary cell of the UE.
Aspect 24: The method of any of aspects 18 through 23, wherein the report message comprises input data to the first machine learning model, statistics for the first machine learning model, a payload size, an indication of the fallback procedure, a first model index corresponding to the first machine learning model, a second model index corresponding to the second machine learning model, or any combination thereof.
Aspect 25: The method of aspect 17, further comprising: receiving, from the base station, a fallback indication message indicating the second mode, wherein the fallback is triggered in response to the fallback indication message.
Aspect 26: The method of any of aspects 17 through 25, further comprising: receiving, from the base station and based at least in part on triggering the fallback, second machine learning model information defining a third machine learning model for the UE different from the first machine learning model and the second mode; and operating using the third machine learning model based at least in part on receiving the second machine learning model information.
Aspect 27: The method of any of aspects 17 through 25, further comprising: receiving, from the base station and based at least in part on triggering the fallback, a configuration message indicating one or more updates to the first machine learning model for the UE; updating the first machine learning model based at least in part on the machine learning model information and the one or more updates; and operating using the updated first machine learning model based at least in part on receiving the configuration message indicating the one or more updates.
Aspect 28: A method for wireless communications at a base station, comprising: transmitting, to a UE, machine learning model information defining a first machine learning model for the UE; triggering fallback for the UE from the first machine learning model to a second mode based at least in part on a fallback procedure for the first machine learning model, the second mode comprising a second machine learning model different from the first machine learning model, a non-machine learning algorithm, or both; and transmitting, to the UE and based at least in part on triggering the fallback, a fallback indication message indicating the second mode.
Aspect 29: The method of aspect 28, further comprising: transmitting, to the UE, a configuration indicating the fallback procedure for the first machine learning model; and receiving, from the UE, a report message comprising a failure report for the first machine learning model based at least in part on the configuration, wherein the fallback is triggered in response to the failure report.
Aspect 30: The method of any of aspects 28 through 29, further comprising: transmitting, to the UE and based at least in part on triggering the fallback, second machine learning model information defining a third machine learning model for the UE different from the first machine learning model and the second mode, one or more updates to the first machine learning model for the UE, or both.
Aspect 31: An apparatus for wireless communications at a UE, comprising a processor; memory coupled with the processor; and instructions stored in the memory and executable by the processor to cause the apparatus to perform a method of any of aspects 1 through 12.
Aspect 32: An apparatus for wireless communications at a UE, comprising at least one means for performing a method of any of aspects 1 through 12.
Aspect 33: A non-transitory computer-readable medium storing code for wireless communications at a UE, the code comprising instructions executable by a processor to perform a method of any of aspects 1 through 12.
Aspect 34: An apparatus for wireless communications at a base station, comprising a processor; memory coupled with the processor; and instructions stored in the memory and executable by the processor to cause the apparatus to perform a method of any of aspects 13 through 16.
Aspect 35: An apparatus for wireless communications at a base station, comprising at least one means for performing a method of any of aspects 13 through 16.
Aspect 36: A non-transitory computer-readable medium storing code for wireless communications at a base station, the code comprising instructions executable by a processor to perform a method of any of aspects 13 through 16.
Aspect 37: An apparatus for wireless communications at a UE, comprising a processor; memory coupled with the processor; and instructions stored in the memory and executable by the processor to cause the apparatus to perform a method of any of aspects 17 through 27.
Aspect 38: An apparatus for wireless communications at a UE, comprising at least one means for performing a method of any of aspects 17 through 27.
Aspect 39: A non-transitory computer-readable medium storing code for wireless communications at a UE, the code comprising instructions executable by a processor to perform a method of any of aspects 17 through 27.
Aspect 40: An apparatus for wireless communications at a base station, comprising a processor; memory coupled with the processor; and instructions stored in the memory and executable by the processor to cause the apparatus to perform a method of any of aspects 28 through 30.
Aspect 41: An apparatus for wireless communications at a base station, comprising at least one means for performing a method of any of aspects 28 through 30.
Aspect 42: A non-transitory computer-readable medium storing code for wireless communications at a base station, the code comprising instructions executable by a processor to perform a method of any of aspects 28 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

Also, as used herein, the phrase “a set” shall be construed as including the possibility of a set with one member. That is, the phrase “a set” shall be construed in the same manner as “one or more.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive, from a base station, machine learning model information defining a machine learning model for the UE;
receive, from the base station, a configuration defining a trigger for reporting a status of the machine learning model;
detect the trigger for reporting the status of the machine learning model based at least in part on the configuration; and
transmit, to the base station, a report message indicating the status of the machine learning model based at least in part on detecting the trigger.

2. The apparatus of claim 1, wherein the instructions are further executable by the processor to cause the apparatus to:
determine a periodic resource pattern for reporting the status of the machine learning model based at least in part on the configuration, wherein the instructions to transmit the report message are executable by the processor to cause the apparatus to transmit the report message in an uplink resource according to the periodic resource pattern.

3. The apparatus of claim 2, wherein the instructions are further executable by the processor to cause the apparatus to:
activate a timer in response to transmitting the report message; and
refrain from transmitting an additional report message according to the periodic resource pattern while the timer is activated.

4. The apparatus of claim 2, wherein the instructions to detect the trigger are executable by the processor to cause the apparatus to:
trigger a transmission of the report message based at least in part on each periodic uplink resource of the periodic resource pattern, one or more conditions of the machine learning model satisfying one or more threshold conditions, an indication from the base station to report the status of the machine learning model, a priority of the machine learning model satisfying a priority threshold, or any combination thereof.

5. The apparatus of claim 1, wherein the instructions to detect the trigger are executable by the processor to cause the apparatus to:
detect a failure of the machine learning model based at least in part on a model outage detection method configured by the configuration, wherein the instructions to transmit the report message are executable by the processor to cause the apparatus to transmit the report message based at least in part on detecting the failure of the machine learning model.

6. The apparatus of claim 5, wherein the instructions are further executable by the processor to cause the apparatus to:
transmit, to the base station, a model failure indication based at least in part on detecting the failure of the machine learning model; and
receive, from the base station and in response to the model failure indication, a failure report query, wherein the instructions to transmit the report message are executable by the processor to cause the apparatus to transmit the report message in response to the failure report query.

7. The apparatus of claim 5, wherein the configuration indicates a threshold number of failure instances and a timer, and wherein the instructions to detect the failure of the machine learning model are executable by the processor to cause the apparatus to:
activate the timer in response to a first failure instance of the machine learning model;
track a count value indicating a number of failure instances of the machine learning model; and
determine that the count value satisfies the threshold number of failure instances prior to expiration of the activated timer, wherein the instructions to detect the failure of the machine learning model are executable by the processor to cause the apparatus to detect the failure of the machine learning model in response to the determining that the count value satisfies the threshold number of failure instances.

8. The apparatus of claim 1, wherein the instructions to detect the trigger are executable by the processor to cause the apparatus to:
receive, from the base station, a configuration message indicating to report the status of the machine learning model, wherein the instructions to transmit the report message are executable by the processor to cause the apparatus to transmit the report message in response to the configuration message indicating to report the status of the machine learning model.

9. The apparatus of claim 8, wherein the configuration message indicating to report the status of the machine learning model comprises a model index corresponding to the machine learning model, a resource indication for transmission of the report message, a timer corresponding to the status of the machine learning model, a timestamp corresponding to the status of the machine learning model, or any combination thereof.

10. The apparatus of claim 1, wherein the instructions to receive the machine learning model information and the instructions to receive the configuration are executable by the processor to cause the apparatus to:
receive, from the base station, a model download message comprising the machine learning model information defining the machine learning model and the configuration defining the trigger for reporting the status of the machine learning model, wherein the configuration is specific to the machine learning model.

11. The apparatus of claim 1, wherein the instructions to receive the configuration are executable by the processor to cause the apparatus to:
receive, from the base station, a model status reporting configuration message separate from the machine learning model information, the model status reporting configuration message comprising an indication of a model index corresponding to the machine learning model or an indication that the configuration corresponds to a general configuration for machine learning models.

12. The apparatus of claim 1, wherein the report message comprises:
a status report for the machine learning model, the status report comprising at least a first model index corresponding to the machine learning model and the status of the machine learning model, wherein the status of the machine learning model comprises model variation information for the machine learning model;
a failure report for the machine learning model, the failure report comprising a payload size, an indication of a fallback mode, the first model index corresponding to the machine learning model, a second model index corresponding to a fallback machine learning model, the status of the machine learning model, or any combination thereof, wherein the status of the machine learning model comprises input data to the machine learning model, statistics for the machine learning model, an output distribution of the machine learning model, or any combination thereof;
or both.

13. An apparatus for wireless communications at a base station, comprising:
a processor;
memory coupled with the processor; and
instructions stored in the memory and executable by the processor to cause the apparatus to:
transmit, to a user equipment (UE), machine learning model information defining a machine learning model for the UE;
transmit, to the UE, a configuration for the UE to report a status of the machine learning model; and
receive, from the UE, a report message indicating the status of the machine learning model based at least in part on the configuration.

14. The apparatus of claim 13, wherein the configuration defines a periodic resource pattern for the UE to report the status of the machine learning model, and wherein the instructions to receive the report message are executable by the processor to cause the apparatus to:
receive the report message according to the periodic resource pattern.

15. The apparatus of claim 13, wherein the configuration defines a model outage detection method, and the instructions are further executable by the processor to cause the apparatus to:
receive, from the UE, a model failure indication based at least in part on the model outage detection method; and
transmit, to the UE and in response to the model failure indication, a failure report query, wherein the instructions to receive the report message are executable by the processor to cause the apparatus to receive the report message in response to the failure report query.

16. The apparatus of claim 13, wherein the instructions are further executable by the processor to cause the apparatus to:
detect a trigger to request the status of the machine learning model, the trigger comprising a performance loss associated with the UE satisfying a performance loss threshold, at least one condition associated with the machine learning model satisfying a status check threshold, or both; and
transmit, to the UE, a configuration message indicating for the UE to report the status of the machine learning model based at least in part on detecting the trigger, wherein the instructions to receive the report message are executable by the processor to cause the apparatus to receive the report message in response to the configuration message indicating for the UE to report the status of the machine learning model.

17. An apparatus for wireless communications at a user equipment (UE), comprising:
a processor;
memory coupled with the processor; and
instructions stored in the memory and executable by the processor to cause the apparatus to:
receive, from a base station, machine learning model information defining a first machine learning model for the UE;
operate using the first machine learning model based at least in part on receiving the machine learning model information;
receive, from the base station, a configuration indicating a fallback procedure for the first machine learning model; and
trigger fallback from operating using the first machine learning model to operating using a second mode based at least in part on the fallback procedure, the second mode comprising a second machine learning model different from the first machine learning model, a non-machine learning algorithm, or both.

18. The apparatus of claim 17, wherein the instructions are further executable by the processor to cause the apparatus to:
monitor a status of the first machine learning model based at least in part on operating using the first machine learning model;
detect a failure of the first machine learning model based at least in part on the configuration and the monitoring; and
transmit a report message comprising a failure report for the first machine learning model and indicating that the fallback is triggered based at least in part on detecting the failure of the first machine learning model.

19. The apparatus of claim 18, wherein the report message indicates the second mode to which the UE falls back in response to detecting the failure of the first machine learning model.

20. The apparatus of claim 18, wherein the report message comprises a request for a fallback indication message, and the instructions are further executable by the processor to cause the apparatus to:
receive, from the base station and in response to the request, the fallback indication message indicating the second mode, wherein the instructions to trigger the fallback are executable by the processor to cause the apparatus to trigger the fallback in response to the fallback indication message.

21. The apparatus of claim 18, wherein the instructions to transmit the report message are executable by the processor to cause the apparatus to:
transmit, to the base station, the report message in an available uplink granted resource, a medium access control element, or both based at least in part on detecting the failure of the first machine learning model, the report message comprising a model failure indication for the first machine learning model and data associated with the failure of the first machine learning model.

22. The apparatus of claim 18, wherein the instructions are further executable by the processor to cause the apparatus to:
transmit, to the base station, a model failure indication for the first machine learning model in an available uplink granted resource, a scheduling request, a medium access control element, a radio resource control configuration message, or any combination thereof based at least in part on detecting the failure of the first machine learning model; and
receive, from the base station and in response to the model failure indication, an indication of an uplink resource to use for the report message comprising the failure report, wherein the instructions to transmit the report message are executable by the processor to cause the apparatus to transmit the report message in the uplink resource.

23. The apparatus of claim 18, wherein the instructions are further executable by the processor to cause the apparatus to:
trigger a physical random access channel procedure based at least in part on the detected failure of the first machine learning model corresponding to a primary cell of the UE.

24. The apparatus of claim 18, wherein the report message comprises input data to the first machine learning model, statistics for the first machine learning model, a payload size, an indication of the fallback procedure, a first model index corresponding to the first machine learning model, a second model index corresponding to the second machine learning model, or any combination thereof.

25. The apparatus of claim 17, wherein the instructions are further executable by the processor to cause the apparatus to:
receive, from the base station, a fallback indication message indicating the second mode, wherein the instructions to trigger the fallback are executable by the processor to cause the apparatus to trigger the fallback in response to the fallback indication message.

26. The apparatus of claim 17, wherein the instructions are further executable by the processor to cause the apparatus to:
receive, from the base station and based at least in part on triggering the fallback, second machine learning model information defining a third machine learning model for the UE different from the first machine learning model and the second mode; and
operate using the third machine learning model based at least in part on receiving the second machine learning model information.

27. The apparatus of claim 17, wherein the instructions are further executable by the processor to cause the apparatus to:
receive, from the base station and based at least in part on triggering the fallback, a configuration message indicating one or more updates to the first machine learning model for the UE;
update the first machine learning model based at least in part on the machine learning model information and the one or more updates; and
operate using the updated first machine learning model based at least in part on receiving the configuration message indicating the one or more updates.

28. An apparatus for wireless communications at a base station, comprising:
a processor;
memory coupled with the processor; and
instructions stored in the memory and executable by the processor to cause the apparatus to:
transmit, to a user equipment (UE), machine learning model information defining a first machine learning model for the UE;
trigger fallback for the UE from the first machine learning model to a second mode based at least in part on a fallback procedure for the first machine learning model, the second mode comprising a second machine learning model different from the first machine learning model, a non-machine learning algorithm, or both; and
transmit, to the UE and based at least in part on triggering the fallback, a fallback indication message indicating the second mode.

29. The apparatus of claim 28, wherein the instructions are further executable by the processor to cause the apparatus to:
transmit, to the UE, a configuration indicating the fallback procedure for the first machine learning model; and
receive, from the UE, a report message comprising a failure report for the first machine learning model based at least in part on the configuration, wherein the instructions to trigger the fallback are executable by the processor to cause the apparatus to trigger the fallback in response to the failure report.

30. The apparatus of claim 28, wherein the instructions are further executable by the processor to cause the apparatus to:
transmit, to the UE and based at least in part on triggering the fallback, second machine learning model information defining a third machine learning model for the UE different from the first machine learning model and the second mode, one or more updates to the first machine learning model for the UE, or both.
